(19) United States
(12) Patent Application Publication
(10) Pub. No.: US 2026/0239343 A1
(43) Pub. Date: Aug. 13, 2026

(54) TECHNIQUES FOR MITIGATING ADJACENT CHANNEL COEXISTENCE INTERFERENCE

(71) Applicant: QUALCOMM Incorporated, San Diego, CA (US)

(72) Inventors: Hui GUO, Beijing (CN); Tien Viet NGUYEN, Bridgewater, NJ (US); Gene Wesley MARSH, San Diego, CA (US); Shailesh PATIL, San Diego, CA (US); Shuanshuan WU, San Diego, CA (US); Kapil GULATI, Belle Mead, NJ (US)

(21) Appl. No.: 19/153,920

(22) PCT Filed: Mar. 15, 2023
(86) PCT No.: PCT/CN2023/081605

§ 371 Date: Aug. 5, 2025

(51) Int. Cl. H04W 72/20; H04L 5/00; H04W 28/26; H04W 72/02; H04W 72/11; H04W 72/12; H04W 72/51; H04W 74/0816; H04W 92/18

(52) U.S. Cl. CPC H04W 72/20; H04L 5/0053; H04W 28/26; H04W 72/02; H04W 72/11; H04W 72/12; H04W 72/51; H04W 74/0816; H04W 92/18

(57) ABSTRACT

Methods, systems, and devices for wireless communications are described. A user equipment (UE) may receive first control information that indicates a first set of resources for transmission of a first message associated with a first radio access technology (RAT) to a second UE. The UE may drop transmission of the first message based on a conflict between the first message and a second message scheduled for transmission by the first UE via a second RAT. The UE UE may communicate, to a modem associated with the first RAT at the first UE, second control information that indicates a retransmission of the first message based on the first message being dropped and in an absence of a feedback message from the second UE responsive to the dropped first message. The UE may then retransmit the first message based on the second control information.

### CROSS REFERENCE

This application is a 371 National Stage of PCT Application No. PCT/CN 2023/081605, filed on Mar. 15, 2023, entitled “TECHNIQUES FOR MITIGATING ADJACENT CHANNEL COEXISTENCE INTERFERENCE”, and assigned to the assignee hereof. The disclosure of the prior Application is considered part of and is incorporated by reference into this Patent Application.

### INTRODUCTION

The following relates to wireless communications, and more specifically to techniques for managing interference between different radio access technologies (RATs) within wireless devices.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communication at a first UE is described. The method may include receiving, from a wireless device, first control information that indicates a first set of resources for transmission of at least a first message associated with a first RAT to a second UE, dropping transmission of the first message based on identification of a conflict between the first set of resources associated with the first message scheduled for transmission by the first UE via the first RAT and a second set of resources associated with a second message scheduled for transmission by the first UE via a second RAT different from the first RAT, communicating, to a modem associated with the first RAT at the first UE, second control information that indicates a retransmission of the first message based on an absence of receipt of a feedback message from the second UE responsive to the dropped first message and on the transmission of the first message being dropped, and transmitting the retransmission of the first message based on the second control information.

An apparatus for wireless communication at a first UE is described. The apparatus may include a processor, and memory coupled with the processor, the processor configured to receive, from a wireless device, first control information that indicates a first set of resources for transmission of at least a first message associated with a first RAT to a second UE, drop transmission of the first message based on identification of a conflict between the first set of resources associated with the first message scheduled for transmission by the first UE via the first RAT and a second set of resources associated with a second message scheduled for transmission by the first UE via a second RAT different from the first RAT, communicating, to a modem associate with the first RAT at the first UE, second control information that indicates a retransmission of the first message based on an absence of receipt of a feedback message from the second UE responsive to the dropped first message and on the transmission of the first message being dropped, and transmit the retransmission of the first message based on the second control information.

Another apparatus for wireless communication at a first UE is described. The apparatus may include means for receiving, from a wireless device, first control information that indicates a first set of resources for transmission of at least a first message associated with a first RAT to a second UE, means for dropping transmission of the first message based on identification of a conflict between the first set of resources associated with the first message scheduled for transmission by the first UE via the first RAT and a second set of resources associated with a second message scheduled for transmission by the first UE via a second RAT different from the first RAT, means for communicating, to a modem associated with the first RAT at the first UE, second control information that indicates a retransmission of the first message based on an absence of receipt of a feedback message from the second UE responsive to the dropped first message and on the transmission of the first message being dropped, and means for transmitting the retransmission of the first message based on the second control information.

A non-transitory computer-readable medium storing code for wireless communication at a first UE is described. The code may include instructions executable by a processor to receive, from a wireless device, first control information that indicates a first set of resources for transmission of at least a first message associated with a first RAT to a second UE, drop transmission of the first message based on identification of a conflict between the first set of resources associated with the first message scheduled for transmission by the first UE via the first RAT and a second set of resources associated with a second message scheduled for transmission by the first UE via a second RAT different from the first RAT, communicating, to a modem associate with the first RAT at the first UE, second control information that indicates a retransmission of the first message based on an absence of receipt of a feedback message from the second UE responsive to the dropped first message and on the transmission of the first message being dropped, and transmit the retransmission of the first message based on the second control information.

In some examples of the method, apparatuses, and non-transitory computer-readable medium described herein, the first UE may be configured to perform retransmissions of the first message based on receipt of one or more feedback messages associated with the first message.

Some examples of the method, apparatuses, and non-transitory computer-readable medium described herein may further include operations, features, means, or instructions for identifying that the second message may be scheduled for transmission via the second RAT based on an evaluation of a message buffer associated with the second RAT at a status check point that may be prior to a start of the first set of resources associated with the first message, where the conflict may be identified based on identifying that the second message may be scheduled for transmission.

In some examples of the method, apparatuses, and non-transitory computer-readable medium described herein, a time interval between the status check point and the start of the first set of resources usable for the first message may be based on one or more processing capabilities of the UE.

Some examples of the method, apparatuses, and non-transitory computer-readable medium described herein may further include operations, features, means, or instructions for identifying the conflict between the first set of resources associated with the first message and the second set of resources associated with the second message based on a start of the first set of resources associated with the first message occurring prior to an end of a clear channel assessment (CCA) procedure associated with the second message in a time domain, where the transmission of the first message may be dropped based on identification of the conflict.

Some examples of the method, apparatuses, and non-transitory computer-readable medium described herein may further include operations, features, means, or instructions for indicating, via the second control information, one or more parameters associated with the retransmission of the first message, where the retransmission of the first message may be performed in accordance with the one or more parameters.

In some examples of the method, apparatuses, and non-transitory computer-readable medium described herein, the one or more parameters associated with the retransmission of the first message include a redundancy version (RV) identifier associated with the retransmission of the first message, a second set of resources associated with the retransmission of the first message, or both.

Some examples of the method, apparatuses, and non-transitory computer-readable medium described herein may further include operations, features, means, or instructions for identifying a third set of resources reserved for retransmissions of the first message based on the first control information, where the retransmission of the first message may be transmitted within the third set of resources.

In some examples of the method, apparatuses, and non-transitory computer-readable medium described herein, the second control information includes a negative acknowledgment (NACK) message communicated to the modem via a medium access control (MAC) layer.

Some examples of the method, apparatuses, and non-transitory computer-readable medium described herein may further include operations, features, means, or instructions for selecting, via the modem, a third set of resources for the retransmission of the first message based on identification of the conflict and based on the first set of resources associated with the first message and the second set of resources associated with the second message including periodic resource sets, where the retransmission of the first message may be transmitted within the third set of resources.

In some examples of the method, apparatuses, and non-transitory computer-readable medium described herein, the first set of resources associated with the first message may be associated with a first semi-persistent scheduling (SPS) counter and the method, apparatuses, and non-transitory computer-readable medium may include further operations, features, means, or instructions for generating a second SPS counter based on identifying the conflict and based on the first set of resources and the second set of resources including periodic resource sets, where the third set of resources may be selected based on the second SPS counter.

Some examples of the method, apparatuses, and non-transitory computer-readable medium described herein may further include operations, features, means, or instructions for transmitting a sidelink control information (SCI) that indicates the third set of resources based on selection of the third set of resources, where the retransmission of the first message may be transmitted based on the SCI.

Some examples of the method, apparatuses, and non-transitory computer-readable medium described herein may further include operations, features, means, or instructions for comparing a first priority associated with the first message, the first RAT, or both, and a second priority associated with the second message, the second RAT, or both, the second priority greater than the first priority, where the transmission of the first message may be dropped based on the comparison.

In some examples of the method, apparatuses, and non-transitory computer-readable medium described herein, the first RAT includes an LTE RAT, a 4G RAT, a 5G RAT, an NR RAT, a 6G RAT, or any combination thereof and the second RAT includes a Wi-Fi access technology, a dedicated short range communication (DSRC) access technology, or both.

In some examples of the method, apparatuses, and non-transitory computer-readable medium described herein, the first RAT includes an LTE vehicle-to-everything (LTE-V2X) RAT, an NR vehicle-to-everything (NR-V2X) RAT, or both.

A method for wireless communication at a first UE is described. The method may include receiving, from a wireless device, first control information that indicates a first set of resources for transmission of one or more messages associated with a first RAT to a second UE, outputting, via a first modem associated with the first RAT to a second modem associated with a second RAT, a coordination message that indicates the first set of resources associated with the first RAT, transmitting, via the first modem associated with the first RAT, a first message within the first set of resources, where the first message is transmitted based on the coordination message, and transmitting, via the second modem associated with the second RAT, a second message within a second set of resources selected based on the coordination message that indicates the first set of resources.

An apparatus for wireless communication at a first UE is described. The apparatus may include a processor, and memory coupled with the processor, the processor configured to receive, from a wireless device, first control information that indicates a first set of resources for transmission of one or more messages associated with a first RAT to a second UE, outputting, via a first modem associate with the first RAT to a second modem associated with a second RAT, a coordination message that indicates the first set of resources associated with the first RAT, transmit, via the first modem associated with the first RAT, a first message within the first set of resources, where the first message is transmitted based on the coordination message, and transmit, via the second modem associated with the second RAT, a second message within a second set of resources selected based on the coordination message that indicates the first set of resources.

Another apparatus for wireless communication at a first UE is described. The apparatus may include means for receiving, from a wireless device, first control information that indicates a first set of resources for transmission of one or more messages associated with a first RAT to a second UE, means for outputting, via a first modem associated with the first RAT to a second modem associated with a second RAT, a coordination message that indicates the first set of resources associated with the first RAT, means for transmitting, via the first modem associated with the first RAT, a first message within the first set of resources, where the first message is transmitted based on the coordination message, and means for transmitting, via the second modem associated with the second RAT, a second message within a second set of resources selected based on the coordination message that indicates the first set of resources.

A non-transitory computer-readable medium storing code for wireless communication at a first UE is described. The code may include instructions executable by a processor to receive, from a wireless device, first control information that indicates a first set of resources for transmission of one or more messages associated with a first RAT to a second UE, outputting, via a first modem associate with the first RAT to a second modem associated with a second RAT, a coordination message that indicates the first set of resources associated with the first RAT, transmit, via the first modem associated with the first RAT, a first message within the first set of resources, where the first message is transmitted based on the coordination message, and transmit, via the second modem associated with the second RAT, a second message within a second set of resources selected based on the coordination message that indicates the first set of resources.

In some examples of the method, apparatuses, and non-transitory computer-readable medium described herein, outputting the coordination message may include operations, features, means, or instructions for outputting, via the coordination message, an indication of a periodicity associated with the first set of resources, where the second set of resources may be selected based on the periodicity.

In some examples of the method, apparatuses, and non-transitory computer-readable medium described herein, outputting the coordination message may include operations, features, means, or instructions for outputting, via the coordination message, an indication of a SPS counter associated with the first set of resources, where the second set of resources may be selected based on the SPS counter.

In some examples of the method, apparatuses, and non-transitory computer-readable medium described herein, the second set of resources may be further selected based on a third set of resources associated with feedback responsive to messages transmitted via the first set of resources.

In some examples of the method, apparatuses, and non-transitory computer-readable medium described herein, the first RAT includes an LTE RAT, a 4G RAT, a 5G RAT, an NR RAT, a 6G RAT, or any combination thereof and the second RAT includes a Wi-Fi access technology, a dedicated short range communication (DSRC) access technology, or both.

In some examples of the method, apparatuses, and non-transitory computer-readable medium described herein, the first RAT includes an LTE vehicle-to-everything (LTE-V2X) RAT, an NR vehicle-to-everything (NR-V2X) RAT, or both.

### BRIEF DESCRIPTION OF THE DRAWINGS

FIG. 1 illustrates an example of a wireless communications system that supports techniques for mitigating adjacent channel coexistence interference in accordance with one or more aspects of the present disclosure.

FIG. 2 illustrates an example of a network architecture that supports techniques for mitigating adjacent channel coexistence interference in accordance with one or more aspects of the present disclosure.

FIG. 3 illustrates an example of a wireless communications system that supports techniques for mitigating adjacent channel coexistence interference in accordance with one or more aspects of the present disclosure.

FIG. 4 illustrates an example of a radio front end configuration (e.g., 3GPP system-on-a-chip (SOC) for 2G-6G communications, WAN RF, V2X DAC, etc.) that supports techniques for mitigating adjacent channel coexistence interference in accordance with one or more aspects of the present disclosure.

FIG. 5 illustrates an example of a resource configuration that supports techniques for mitigating adjacent channel coexistence interference in accordance with one or more aspects of the present disclosure.

FIGS. 6A and 6B illustrate examples of resource configurations that support techniques for mitigating adjacent channel coexistence interference in accordance with one or more aspects of the present disclosure.

FIG. 7 illustrates an example of a resource configuration that supports techniques for mitigating adjacent channel coexistence interference in accordance with one or more aspects of the present disclosure.

FIG. 8 illustrates an example of a process flow that supports techniques for mitigating adjacent channel coexistence interference in accordance with one or more aspects of the present disclosure.

FIG. 9 illustrates an example of a process flow that supports techniques for mitigating adjacent channel coexistence interference in accordance with one or more aspects of the present disclosure.

FIGS. 10 and 11 illustrate block diagrams of devices that support techniques for mitigating adjacent channel coexistence interference in accordance with one or more aspects of the present disclosure.

FIG. 12 illustrates a block diagram of a communications manager that supports techniques for mitigating adjacent channel coexistence interference in accordance with one or more aspects of the present disclosure.

FIG. 13 illustrates a diagram of a system including a device that supports techniques for mitigating adjacent channel coexistence interference in accordance with one or more aspects of the present disclosure.

FIGS. 14 through 16 illustrate flowcharts showing methods that support techniques for mitigating adjacent channel coexistence interference in accordance with one or more aspects of the present disclosure.

### DETAILED DESCRIPTION

Some wireless devices, such as UEs, may include dual-radio devices that are able to communicate via multiple RATs. Examples of RATs include LTE, NR, wireless local area network (WLAN), DSRC, etc. In some cases, such dual-radio devices may include multiple different modems associated with the multiple different RATs, such as a first modem for NR-V2X communications and a second modem for DSRC (e.g., Wi-Fi) communications. In cases where multiple RATs use adjacent frequency resources (e.g., contiguous and/or consecutive frequency resources), messages transmitted by the UE using the multiple RATs may result in adjacent channel coexistence interference, which may degrade the performance and reliability of communications on each of the respective RATs. For instance, in cases where V2X and DSRC communications are performed via adjacent channels or frequency resources, V2X messages transmitted by a UE may interfere with DSRC messages transmitted by the UE, thereby resulting in adjacent channel coexistence interference, or “in-device coexistence interference” experienced by the UE. Such in-device coexistence interference may reduce an efficiency and reliability of wireless communications performed by the UE.

In some cases, a dual-radio device may simply drop V2X messages to avoid collisions with DSRC communications. However, because V2X is a hybrid automatic repeat request (HARQ)-based communication scheme, the UE may not receive any feedback messages (e.g., NACKs) that trigger retransmission of the dropped V2X message. Thus, the UE may not be triggered to re-transmit the dropped message, and may therefore not re-transmit the dropped message, which may result in a loss of information and less reliable V2X communications.

Accordingly, aspects of the present disclosure are directed to techniques for mitigating in-device coexistence interference resulting from transmissions performed by a dual-radio device. In particular, aspects of the present disclosure are directed to communications between baseband components and modems associated with a RAT of a dual-radio device to enable the dual-radio device to drop messages, and still trigger retransmissions of the dropped messages. For example, a dual-radio device (e.g., UE) may be scheduled to transmit messages using a first RAT (e.g., NR-V2X, LTE-V2X). However, the UE may elect to drop transmission of a V2X message if the UE identifies a conflict with a second RAT (e.g., DSRC). In this example, because the message was dropped, the UE will not receive a NACK to trigger retransmission of the dropped message. As such, in order to trigger retransmission of the dropped message, radio frequency (RF) components (e.g., application processor, baseband component, etc.) of a modem associated with the V2X RAT may communicate a message to the baseband component of the modem associated with the V2X RAT to trigger retransmission of the dropped message even though the UE never received a feedback message that would otherwise trigger retransmission. In other words, techniques described herein may facilitate V2X transmissions to be performed on retransmission resources in the event a V2X transmission is dropped. Specifically, a modem associated with V2X may trigger resource reselection to avoid consecutive transmission drop due to in-device Tx-Tx dropping.

For the purposes of the present disclosure, a wireless device may “drop” a message by refraining from transmitting the message in the originally scheduled resources for the message. In such cases, after “dropping” a message, the wireless device may perform a “retransmission” for the message (e.g., retransmit the message) in resources that are subsequent to the originally scheduled resources (e.g., the retransmission of the message may occur after the message was originally dropped). Moreover, in some cases, the wireless devices may drop a message (e.g., refrain from transmitting the message) if the resources for the message conflict with resources associated with another RAT or another message. In such cases, a “conflict” may refer to a situation in which resources for a first message (and/or first RAT) overlap in the time domain with resources for a second message (and/or second RAT). In particular, resources on adjacent frequency bands (e.g., resources that do not overlap in the frequency domain, but which are proximate to one another in the frequency domain) may be said to conflict with one another if the resources at least partially overlap in the time domain.

As it is used herein, the term “control information” may include any information exchanged between devices, or information exchanged between components of a same device, that is used to coordinate wireless communications. In this regard, the term “control information” may include any type of control message, such as radio resource control (RRC) messages, downlink control information (DCI) messages, uplink control information (UCI) messages, MAC control element (MAC-CE) messages, SCI messages, and the like. Moreover, the term “control information” may refer to intra-device information (e.g., information exchanged between components of the same device, such as coordination messages exchanged between modems of different RATs) that is used to coordinate communications across the respective components of the device.

Additional or alternative implementations of the present disclosure are directed to communications between multiple different modems associated with multiple different RATs at a UE in order to mitigate in-device coexistence interference resulting from transmissions performed by a dual-radio device. For example, a dual-radio UE may be configured to perform communications via a first RAT using a first modem and a second RAT using a second modem. In this example, the first modem may communicate coordination messages to the second modem to help avoid interference between transmissions performed using the first and second RATs. For example, the coordination messages may indicate resources used by the first modem to transmit messages via the first RAT so that the second modem may select new resources for the second RAT that will reduce or eliminate in-device coexistence interference resulting from messages transmitted using the second modem (and associated RF components).

For the purposes of the present disclosure, the term “modem” may refer to a component of a wireless device that is used to modulate and/or demodulate analog signals communicated by the wireless device. Moreover, as it is used herein, the term “coordination message” may refer to messages or information exchanged between different modems of a wireless device that are associated with different RATs. In other words, the terms “coordination message” and “coordination information” may refer to messages/information that is exchanged between different components of a same wireless device to coordinate communications across different RATs.

Aspects of the disclosure are initially described in the context of wireless communications systems. Aspects of the disclosure are further described in the context of an example network architecture, example resource configurations, and an example process flow Aspects of the disclosure are further illustrated by and described with reference to apparatus diagrams, system diagrams, and flowcharts that relate to techniques for mitigating adjacent channel coexistence interference.

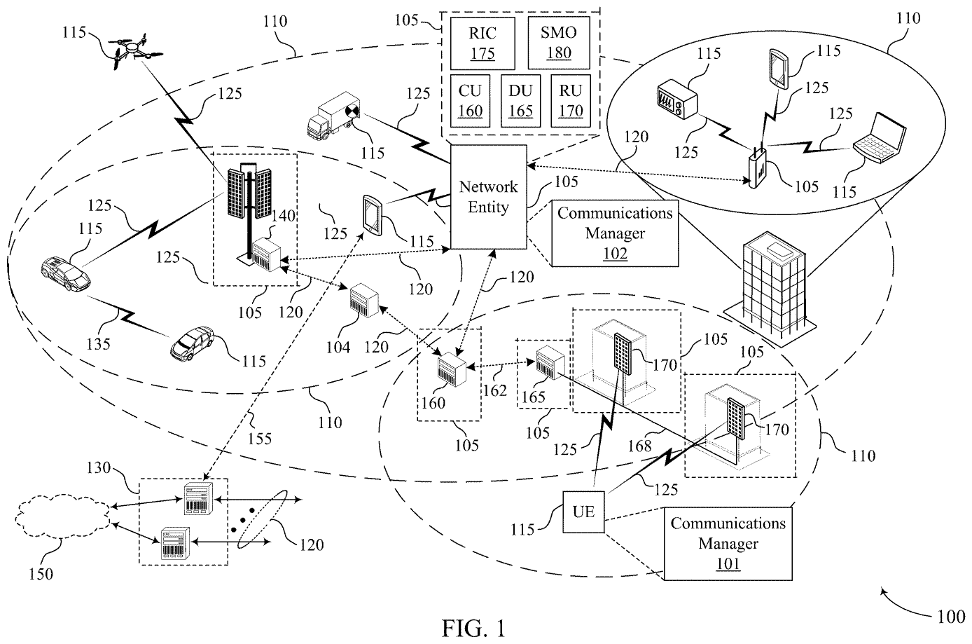

FIG. 1 illustrates an example of a wireless communications system 100 that supports techniques for mitigating adjacent channel coexistence interference in accordance with one or more aspects of the present disclosure. The wireless communications system 100 may include one or more network entities 105, one or more UEs 115, and a core network 130. In some examples, the wireless communications system 100 may be an LTE network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature, and may include a network entity communications manager 102. In some examples, network entities 105 and UEs 115 may wirelessly communicate via one or more communication links 125 (e.g., an RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs) using UE communications manager 101.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a network entity also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support configured grant (CG) and SPS for frequent BWP and CC switching as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP (BWP)) that is operated according to one or more physical layer channels for a given RAT (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum, and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regards to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell may cover a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple CCs.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some implementations, wireless devices (e.g., UEs 115, IAB nodes, etc.) of the wireless communications system 100 may be configured to support techniques for mitigating in-device coexistence interference resulting from transmissions performed by a dual-radio device. In particular, dual-radio wireless devices of the wireless communications system 100 may support communications between baseband components and modems associated with a RAT of a dual-radio devices to enable the respective dual-radio devices to drop messages, and still trigger retransmissions of the dropped messages.

For example, a dual-radio device (e.g., dual-radio UE 115) of the wireless communications system 100 may be scheduled to transmit messages using a first RAT (e.g., NR-V2X, LTE-V2X). However, the dual-radio UE 115 may elect to drop transmission of a V2X message if the device identifies a conflict with a second RAT (e.g., DSRC). In this example, because the message was dropped, the UE 115 may not receive a NACK to trigger retransmission of the dropped message. As such, in order to trigger retransmission of the dropped message, RF components of a modem associated with the V2X RAT may communicate a message to the baseband component of the modem to trigger retransmission of the dropped message even though the UE 115 never received a feedback message that would otherwise trigger retransmission.

In additional or alternative aspects, dual-radio devices of the wireless communications system 100 may support communications between multiple different modems associated with multiple different RATs at of the respective dual-radio devices in order to mitigate in-device coexistence interference resulting from transmissions performed by a dual-radio device. For example, a dual-radio UE 115 of the wireless communications system 100 may be configured to perform communications via a first RAT using a first modem and a second RAT using a second modem. In this example, the first modem may communicate coordination messages to the second modem to help avoid interference between transmissions performed using the first and second RATs.

For example, the coordination messages may indicate resources used by the first modem to transmit messages via the first RAT so that the second modem may select new resources for the second RAT that will reduce or eliminate in-device coexistence interference resulting from messages transmitted using the second modem.

Techniques described herein may help reduce in-device coexistence interference (e.g., adjacent channel coexistence interference) within dual-radio devices. In particular, aspects of the present disclosure may enable dual-radio devices to drop messages associated with one RAT in order to avoid in-device coexistence interference with messages transmitted via a second RAT. Moreover, techniques described herein may enable the dual-radio devices to autonomously trigger retransmissions of dropped messages using signaling between components of a modem associated with the dropped transmissions. Further, techniques described herein may enable modems associated with different RATs of dual-radio devices to exchange coordination messages with one another, where the coordination messages enable the modems to select resources that will reduce or eliminate in-device coexistence interference between the respective RATs. As such, techniques described herein may reduce in-device coexistence interference (e.g., adjacent channel coexistence interference) within the wireless communications system, and lead to more efficient and reliable communications.

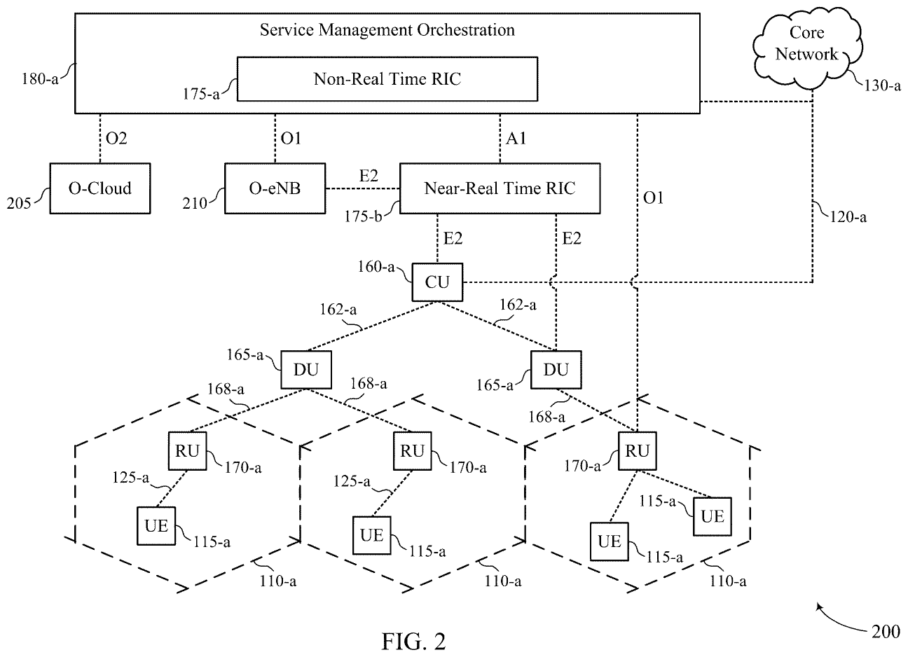

FIG. 2 illustrates an example of a network architecture 200 (e.g., a disaggregated base station architecture, a disaggregated RAN architecture) that supports techniques for mitigating adjacent channel coexistence interference in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an Al interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

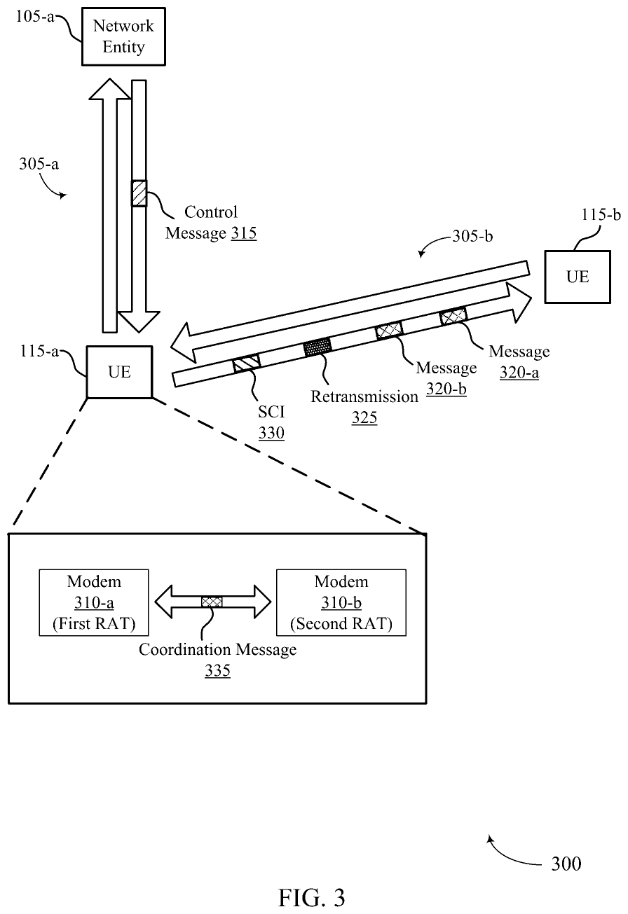

FIG. 3 illustrates an example of a wireless communications system 300 that supports techniques for mitigating adjacent channel coexistence interference in accordance with one or more aspects of the present disclosure. Aspects of the wireless communications system 300 may implement, or be implemented by, aspects of wireless communications system 100, the network architecture 200, or both. For example, the wireless communications system 300 may include dual-radio wireless devices (e.g., UEs 115) that support techniques for mitigating in-device coexistence interference resulting from transmissions performed by the respective dual-radio devices, as described previously herein.

The wireless communications system 300 may include a first UE 115-a, a second UE 115-b, and a network entity 105-a, which may be examples of UEs 115 and network entities 105 as described with reference to FIGS. 1-2. In some aspects, the UEs 115-a, 115-b may communicate with the network entity 105-a via communication links 305, such as the communication link 305-a between the first UE 115-a and the network entity 105-a. In some cases, the communication link 305-a may include example of an access link (e.g., a Uu link). The communication link 305-a may include a bi-directional link that can include both uplink and downlink communication. For example, the first UE 115-a may transmit uplink transmissions, such as uplink control signals or uplink data signals, to the network entity 105-a using the communication link 305-a, and the network entity 105-a may transmit downlink transmissions, such as downlink control signals or downlink data signals, to the first UE 115-a using the communication link 305-a. Moreover, in some aspects, the first UE 115-a and the second UE 115-b may communicate with one another using a communication link 305-b, which may be an example of a sidelink communication link or PC5 link.

As noted previously herein, some wireless devices (e.g., UEs 115-a, 115-b) may include dual-radio devices that are able to communicate via multiple RATs. In some cases, such dual-radio devices may include multiple different modems associated with the multiple different RATs. For example, the first UE 115-a illustrated in FIG. 3 may include an example of a dual-radio device, where the UE 115-a includes a first modem 310-a associated with a first RAT, and a second modem 310-b associated with a second RAT. In this example, the first RAT may include a V2X RAT (e.g., NR-V2X, LTE-V2X) that is configured to support vehicular applications and use-cases (e.g., safety and emergency signaling). Moreover, the second RAT may include a DSRC RAT (e.g., Wi-Fi, or other 802.11p RAT).

In some aspects, the first modem 310-a and the second modem 310-b may be communicatively coupled to one another, as will be described in further detail herein. In some cases, the respective modems 310 may be associated with separate RF chains and/or hardware components (e.g., separate RF chains/hardware that are dedicated to the respective modems/RATs). In additional or alternative implementations, the respective modems 310 may share one or more RF chains and/or hardware components. In further implementations, some RF components may be shared across the respective modems 310, while other hardware components are dedicated to the respective modems 310 (e.g., not shared across the respective modems 310).

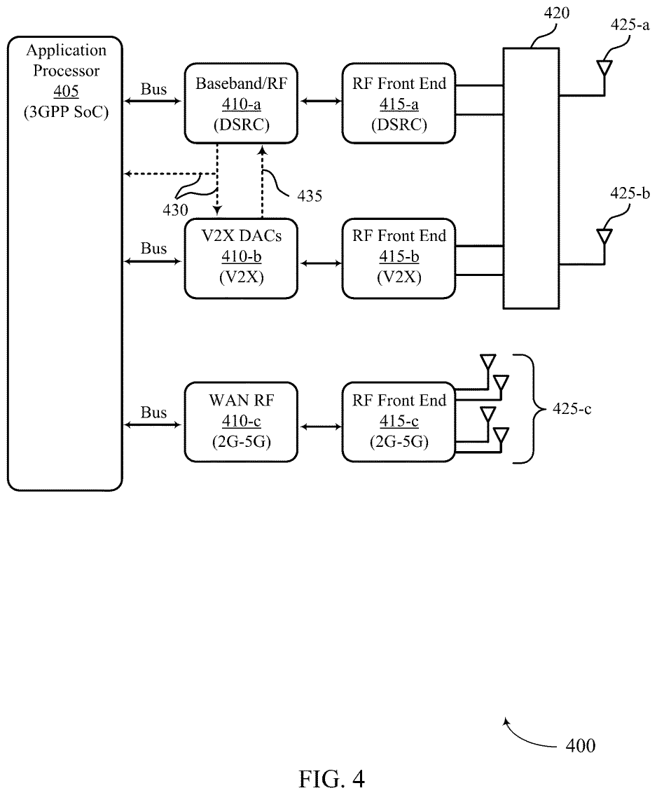

The ability to share RF components across the respective modems 310 may be further shown and described with reference to FIG. 4.

FIG. 4 illustrates an example of a radio front end configuration 400 that supports techniques for mitigating adjacent channel coexistence interference in accordance with one or more aspects of the present disclosure. Aspects of the radio front end configuration 400 may implement, or be implemented by, aspects of wireless communications system 100, the network architecture 200, the wireless communications system 300, or any combination thereof. In particular, the radio front end configuration 400 illustrates how RF components may be shared across multiple RATs and/or modems, such as DSRC and V2X modems.

In some aspects, the radio front end configuration 400 may be implemented at the first UE 115-a illustrated in FIG. 3 for DSRC/V2X coexistence. As shown in FIG. 4, the radio front end configuration 400 may include an application processor 405, which may include an example of a system-on-a-chip (SoC) at the first UE 115-a. the application processor 405 may be communicatively coupled (via one or more busses, such as USB, PCIe, SDIO) to a baseband component 410-a for DSRC communications, a V2X digital-to-analog converter (DAC) component 410-b for V2X communications, and a WAN RF component 410-c for 2G/3G/4G/5G/6G communications (as well as future RATs).

The baseband component 410-a may include a SoC baseband and RF components for DSRC communications (e.g., 802.11p communications). The baseband component 410-a may be communicatively coupled to an RF front end 415-a associated with DSRC communications (e.g., ITS-G5). The RF front end 415-a may include power amplifiers, low noise amplifiers (LNAs), and the like. Similarly, the V2X DAC component 410-b (e.g., I/Q analog-to-digital (A2D) DACs) may be communicatively coupled to an RF front end 415-b for V2X communications, and the WAN RF component 410-c may be communicatively coupled to an RF front end 415-b for 2G/3G/4G/5G communications.

The RF front ends 415-a, 415-b for the DSRC and V2X communications may be communicatively coupled with a Tx/Rx switching network 420 that includes various amplifiers, switches, splitters, LNAs, and the like. The Tx/Rx switching network 420 may couple the RF front ends 415 with a first antenna module 425-a associated with DSRC communications, and a second antenna module 425-b that is shared for both DSRC and V2X communications. Similarly, the RF front end 415-c may be coupled with a third antenna module 425-c for 2G/3G/4G/5G communications.

In some implementations, the baseband component 410-a associated with DSRC communications may communicate signals 430 to a baseband component associated with V2X communications (e.g., NR-V2X baseband). Conversely, the V2X DAC component 410-b may communicate signals 435 (e.g., co-ex manager signals/interrupts) to the baseband component 410-a. As described in further detail herein, the signals 430 and/or 435 may be used to reduce or eliminate in-device coexistence interference across the respective RATs, as described in further detail herein.

Reference will again be made to the wireless communications system 300 illustrated in FIG. 3. In some networks, such as wireless networks in Europe, V2X and DSRC communications may operate in adjacent channels or frequency bands. For example, NR-V 2X communications may be performed between 5875-5895 MHz, where DSRC communications are performed between 5895-5905 MHz. In such cases where multiple RATs (e.g., NR-V2X and DSRC) use adjacent frequency resources, messages transmitted by dual-radio devices using the multiple RATs may result in adjacent channel coexistence interference, which may degrade the performance and reliability of communications on each of the respective RATs. In other words, in cases where the first and second RATs illustrated in FIG. 3 operate in adjacent frequency bands, communications performed (e.g., transmitted, received) by the first modem 310-a may cause interference with communications performed by the second modem 310-b, and vice versa.

In the context of V2X communications (e.g., NR-V2X), a wireless device (e.g., UEs 115-a, 115-b) may be configured to perform sidelink sensing procedures to determine whether or not sidelink resources are available for sidelink communications via the communication link 305-b. When performing a sidelink sensing procedure, a wireless device may perform measurements (e.g., reference signal received power (RSRP) measurements) within a sensing window of size To, where To may be configured by the network, and may be between 100 ms and 1100 ms. The measurements (e.g., RSRP measurements) performed during the sensing window may be projected onto reservations within a future resource selection window. That is, measurements performed during the sensing window may be used to determine whether resources are available for use within a future time interval. In particular, the wireless device may compare the measurements (e.g., RSRP measurements) performed within the selection window with a measurement threshold, and may increases the threshold until a configurable percentage of resources have measurements (e.g., RSRP measurements) below the respective threshold.

Comparatively, in the context of DSRC communications (e.g., Wi-Fi, or other 802.11p communication scheme), a wireless device may perform a CCA procedure to determine whether or not sidelink resources are available for use. For a CCA procedure, once a wireless device has data to be transmitted, the wireless device may perform a listen-before-talk (LBT) procedure by performing measurements for a sidelink channel. If the channel is not being used by other devices (e.g., measurements less than some threshold), the wireless device may determine that the channel is available, and may therefore reserve resources for communications performed over the channel. Conversely, if the channel is being used by another device (e.g., measurements greater than some threshold), the wireless device may determine that the channel is currently busy, and may wait some back-off time interval before performing another LBT procedure in order to avoid collisions.

In the frequency regions in which both C-V2X (e.g., NR-V2X, LTE-V2X) and DSRC are deployed, some wireless devices (e.g., first UE 115-a) may operate as dual-radio devices. For example, the UE 115-a may transmit basic safety messages (BSMs) and cooperative awareness messages (CAMs) via the second RAT (e.g., DSRC), and may transmit advance traffic via the first RAT (e.g., transmit sensor sharing messages via NR-V2X). In cases where multiple devices within the same wireless device (e.g., multiple modems 310 within the same UE 115-a or car) are associated with the same RF Tx chain, the wireless device may utilize TDM in order to avoid collisions across the respective RATs (e.g., apply TDM when more than one type of RAT/device is about to transmit a packet).

In some cases, in order to avoid collisions with messages transmitted using the respective RATs, the UE 115-a may simply drop V2X messages (e.g., messages transmitted via the first RAT) to avoid collisions with DSRC communications (e.g., messages transmitted via the second RAT). However, because V2X is a HARQ-based communication scheme, the UE 115-a may not receive any feedback messages (e.g., NACKs) that trigger retransmission of the dropped V2X message, and may therefore refrain from re-transmitting the dropped message, which may result in a loss of information and less reliable V2X communications.

Accordingly, aspects of the present disclosure are directed to techniques for mitigating in-device coexistence interference resulting from transmissions performed by a dual-radio device. In particular, aspects of the present disclosure are directed to techniques that enable wireless devices to identify collisions (e.g., via a chip or RF coordination), determine whether to drop a transmission, and techniques to mitigate loss of communications due to dropped messages. As such, techniques described herein may facilitate V2X transmissions to be performed on retransmission resources in the event a V2X transmission is dropped. Specifically, a modem 310 associated with V2X may trigger resource reselection to avoid consecutive transmission drop due to in-device Tx-Tx dropping.

Additional or alternative aspects of the present disclosure are directed to communications between multiple different modems 310 associated with multiple different RATs at a wireless device (e.g., first UE 115-a) in order to mitigate in-device coexistence interference resulting from transmissions performed by a dual-radio device. In particular, aspects of the present disclosure are directed to the exchange of coordination messages 335 exchanged between modems 310 associated with different RATs in order to mitigate or eliminate in-device coexistence interface between the respective RATs. In such cases, coordination messages 335 may indicate resources usable for communications on the respective RATs so that the respective modems 310 may select (e.g., re-select) resources that will avoid in-device interference (e.g., DSRC and NR-V2X coordination on SPS resource reservation).

For example, referring to the wireless communications system 300 illustrated in FIG. 3, the first UE 115-a may be configured to perform communications via a first RAT (e.g., using first modem 310-a) and communications via a second RAT (e.g., using second modem 310-b). For example, the first UE 115-a may be configured to perform V2X communications using the first modem 310-a, and may be configured to perform DSRC communications using the second modem 310-b.

In some aspects, the first UE 115-a may receive, from the network entity 105-a, a control message 315 that indicates a set of resources usable by the first UE 115-a for transmitting messages (e.g., first message 320-a) associated with a first RAT to the second UE 115-b. For example, the control message 315 may indicate a set of V2X resources for transmitting a V2X message (e.g., first message 320-a) to the second UE 115-b. In this example, retransmissions of the scheduled V2X message (e.g., first message 320-a) may be triggered based on feedback messages (e.g., NACK messages) received responsive to the V2X message. That is, the first RAT (e.g., V2X) may include a HARQ-based RAT in which retransmissions are triggered based on reception of NACK messages communicated to the first modem 310-a (e.g., baseband component of the first modem 310-a) via a MAC layer (e.g., after transmitting a V2X message, the first UE 115-a may retransmit the V2X message if it receives a NACK message from the second UE 115-b responsive to the V2X message).

In some aspects, the first UE 115-a may determine whether or not the resources allocated for the first RAT conflict with communications scheduled to be performed via the second RAT. In other words, the first UE 115-a may determine whether there is a conflict between messages to be transmitted by the first UE 115-a via V2X (e.g., first message 320-a), and messages to be transmitted by the first UE 115-a via DSRC (e.g., second message 320-b).

For example, the first UE 115-a may identify the conflict based on determining that the first message 320-a (e.g., V2X message) starts before an end of a CCA procedure associated with the second message 320-b (e.g., DSRC message). By way of another example, the first UE 115-a may identify a conflict based on identifying that the first message 320-a (e.g., V2X message) and the second message 320-b (e.g., DSRC message) are scheduled to be transmitted in overlapping time resources. In some aspects, identification of the conflict may be performed at the status check point that is determined relative to the first message 320-a.

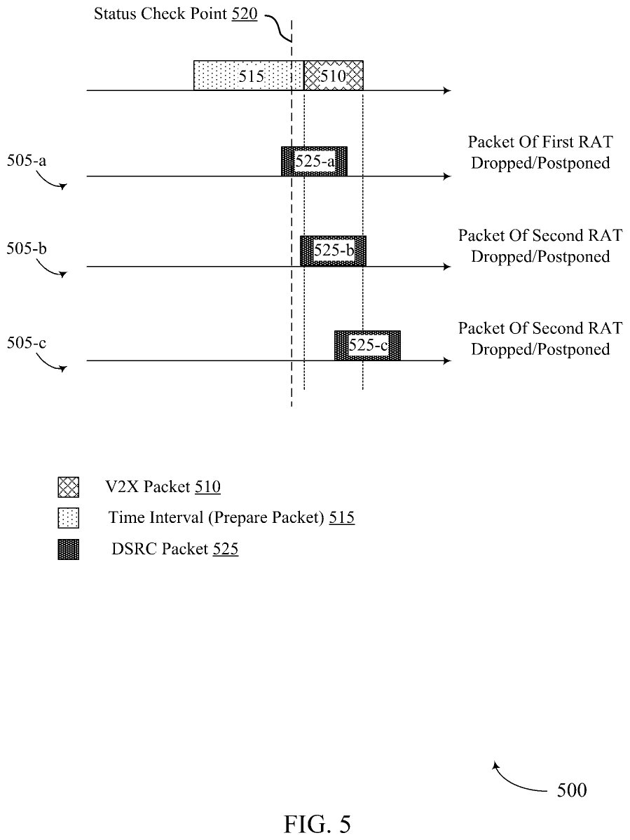

Identification of conflicts between messages 320 to be transmitted by the first UE 115-a using different RATs may be further shown and described with reference to FIG. 5.

FIG. 5 illustrates an example of a resource configuration 500 that supports techniques for mitigating adjacent channel coexistence interference in accordance with one or more aspects of the present disclosure. Aspects of the resource configuration 500 may implement, or be implemented by, aspects of wireless communications system 100, the network architecture 200, the wireless communications system 300, the radio front end configuration 400, or any combination thereof. In particular, the resource configuration 500 illustrates multiple example configurations 505 illustrating conflicts between messages to be performed by the first UE 115-a using different RATs, such as V2X and DSRC.

As described previously herein, the first UE 115-a may receive a control message 315 that indicates a set of resources usable by the first UE 115-a for transmitting a first message associated with a first RAT (e.g., V2X packet 510). In this example, the V2X packet 510 may include a physical sidelink control channel (PSCCH) packet, a physical sidelink shared channel (PSSC packet, or a physical sidelink feedback channel (PSFCH) packet. Upon receiving or otherwise identifying the set of resources allocated for the V2X packet 510, the first UE 115-a may identify whether the first UE 115-a is also scheduled to transmit messages/packets via a second RAT. In other words, the first UE 115-a may identify a second set of resources that are usable for transmitting DSRC packets 525. In this regard, the V2X packet 510 and the DSRC packets 525 illustrated in FIG. 5 may be examples of the first message 320-a and the second message 320-b, respectively, as illustrated in FIG. 3.

In some aspects, the first UE 115-a may identify the messages/packets to be transmitted using the second RAT (e.g., DSRC packets 525) by evaluating a message buffer associated with the second RAT. For instance, as shown in FIG. 5, the first UE 115-a may evaluate the message buffer of the second RAT at a status check point 520 that is some time prior to a start of the set of resources usable for the V2X packet.

In some aspects, the time interval between the status check point 520 and the start of the V2X packet 510 (e.g., start of the first set of resources for the V2X packet 510) may be based on one or more processing capabilities of the first UE 115-a (e.g., based on a hardware reaction time). For instance, the status check point 520 may be 60us prior to the start of the scheduled V2X packet 510 (e.g., 60 μs prior to the start of the first set of resources for the V2X packet 510). In this example, the 60 μs may be the length of a Wi-Fi/DSRC slot, plus an interval associated with a distributed inter-frame spacing (DIFS).

Stated differently, the first UE 115-a may check whether there is a conflict between the first RAT (e.g., V2X) and the second RAT (e.g., DSRC) by checking message buffers at some status check point 520. In some cases, the status check point (e.g., DSRC device status point) may be within a time interval 515 during which the first UE 115-a prepares the V2X packet 510 for transmission.

In a first example, as shown in the first configuration 505-a, at the status check point 520, the first UE 115-a may determine that a DSRC modem is about to transmit a DSRC packet 525-a. That is, the DSRC packet 525-a may have already arrived prior to the status check point 520, and CCA for the DSRC packet 525-a has started. In this example, the first UE 115-a may identify a conflict between the V2X packet 510 and the DSRC packet 525-a. As such, in the first configuration 505-a, the first UE 115-a may drop the V2X packet 510 (e.g., refrain from transmitting the V2X packet 510 within the first set of resources).

By way of another example, as shown in the second configuration 505-b, a DSRC packet 525-b may arrive later than the status check point 520, such that the first UE 115-a does not identify the DSRC packet 525-b at the status check point 520. As such, the first UE 115-a may determine that there is no conflict at the status check point 520, and may transmit the V2X packet 510 within the allocated resources. In this example, CCA for the DSRC packet 525-b may not be finished by the time the V2X packet 510 is transmitted. As such, energy from V2X packet 510 may saturate the DSRC Rx chain, causing CCA for the DSRC packet 525-b to freeze (e.g., DSRC packet 525-b not transmitted in originally scheduled resources). In this regard, the second modem 310-b associated with the DSRC RAT may resume CCA for the DSRC packet 525-b after transmission of the V2X packet 510 has concluded.

By way of another example, as shown in the third configuration 505-c, a DSRC packet 525-c may arrive during transmission of the V2X packet 510 (e.g., later than the status check point 520), such that the first UE 115-a does not identify the DSRC packet 525-c at the status check point 520. As such, the first UE 115-a may determine that there is no conflict at the status check point 520, and may transmit the V2X packet 510 within the allocated resources. As such, energy from V2X packet 510 may saturate the DSRC Rx chain, causing CCA for the DSRC packet 525-c to freeze (e.g., DSRC packet 525-c not transmitted in originally scheduled resources). In this regard, the second modem 310-b associated with the DSRC RAT may resume CCA for the DSRC packet 525-c after transmission of the V2X packet 510 has concluded.

The examples described with reference to the configurations 505 illustrated in FIG. 5 are provided solely for example. For instance, in some cases, upon identifying a conflict (as shown in the first configuration 505), the first UE 115-a may determine which packet to drop (e.g., whether to drop the V2X packet 510 or the DSRC packet 525-a) based on relative priorities of the individual packets, relative priorities of the respective RATs, or both.

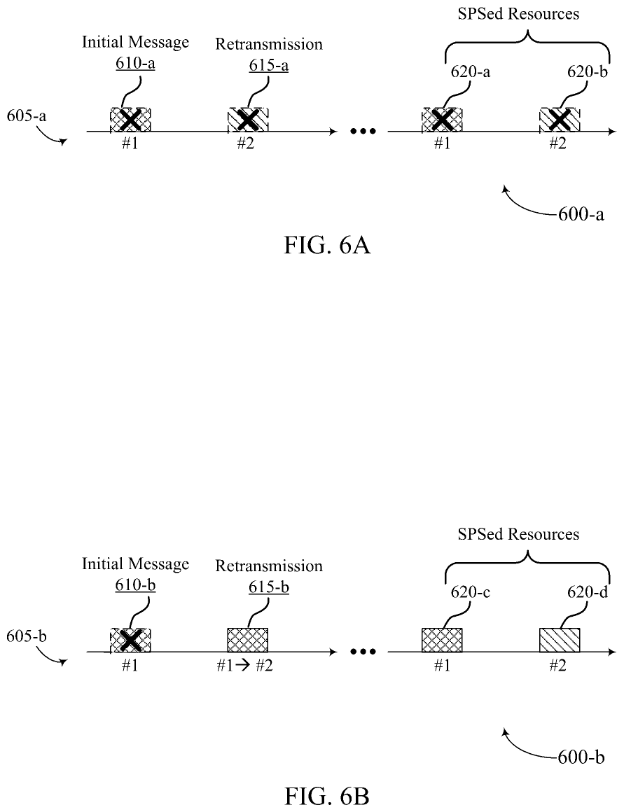

In cases where dropped packets are associated with periodic resource sets (e.g., SPSed resources), dropping transmission of a packet may result in multiple dropped transmissions. As such, aspects of the present disclosure are directed to techniques to reduce or eliminate multiple dropped transmissions. This may be further shown and described with reference to FIGS. 6A and 6B.

FIGS. 6A and 6B illustrate examples of resource configurations 600-a, 600-b that support techniques for mitigating adjacent channel coexistence interference in accordance with one or more aspects of the present disclosure. Aspects of the resource configurations 600-a, 600-b may implement, or be implemented by, aspects of wireless communications system 100, the network architecture 200, the wireless communications system 300, the radio front end configuration 400, the resource configuration 500, or any combination thereof.

In some wireless communications systems, dropping transmission of one message/packet may lead to corresponding retransmissions also being dropped. For example, as shown in a first configuration 605-a illustrated in FIG. 6A, the first UE 115-a may drop an initial message 610-a. For instance, as shown and described in FIG. 5, the first UE 115-a may drop a V2X packet 510. In this regard, the initial message 610-a illustrated in FIG. 6A may be an example of the V2X packet 510 illustrated in FIG. 5. The drop may take place at the RF hardware components of the first modem 310-a associated with the V2X RAT. As such, in this example, the first modem 310-a associated with the V2X RAT may not be aware of the drop.

Continuing with reference to the first configuration 605-a, because V2X is associated with a HARQ-based feedback mechanism, the first UE 115-a may not receive any NACK message since the initial message 610-a was dropped. As such, the retransmission 615-a of the initial message 610-a may also be dropped (due to the absence of a NACK received in response to the initial message 610-a). In other words, the retransmission 615-a is also dropped because no HARQ feedback was received to trigger retransmission. Furthermore, SPSed resources 620-a and 620-b associated with the resources of the initial message 610-a and the retransmission 615-a may also be dropped due to the fact that the initial message 610-a and the retransmission 615-a were dropped. As a result, in some cases, dropping the initial message 610-a may result in a cascading effect where subsequent retransmissions 615 and corresponding SPSed resources 620 are also dropped.

In order to avoid the case with multiple dropped transmissions and retransmissions, as shown in the first configuration 605-a, aspects of the present disclosure are directed to signaling between RF components and corresponding modems 310 that may be used to trigger retransmissions and prevent multiple dropped transmissions and retransmissions.

For example, referring to the second configuration 605-b illustrated in FIG. 6B, the first UE 115-a may drop transmission of an initial message 610-b. As described previously herein, the drop may take place at the RF hardware of the first modem 310-a associated with the first RAT. To avoid dropping of following retransmissions (e.g., retransmission 615-b), the baseband component of the first modem 310-a may need to be made aware of the drop. As such, in some aspects, the RF components associated with the first modem 310-a may transmit a message or signal indicating the drop to the baseband components of the first modem 310-a.

In this example, upon being informed that the initial message 610-a has been dropped, the baseband component of the modem 310-a may attempt to retransmit the initial message 610-b at some later time within resources selected for retransmission. For example, as shown in FIG. 6B, upon receiving a message indicating that the initial message 610-b has been dropped due to a conflict or collision, the baseband component may perform (e.g., transmit) the retransmission 615-b. Moreover, as compared to the first configuration 605-a where dropping the initial message 610-a resulted in dropping the retransmission 615-a and the SPSed resources 620-a, 620-b, dropping the initial message 610-b in the second configuration 605-b may have no impact on the following SPSed resources 620-c, 620-d associated with the resources for the initial message 610-b and the retransmission 615-b.

In some aspects, the first UE 115-a may assign an RV identifier for the retransmission 615-b, and may indicate the RV identifier in an SCI message 330 (e.g., SCI-2) communicated to the second UE 115-b. In some cases, to avoid collision with other UEs 115 due to SCI-1 missing, the retransmission 615-b may also indicate resources reserved for the “initial transmission” (e.g., initial message 610-b) in SCI-1. Additionally, or alternatively, the baseband component of the first modem 310-a may transmit the retransmission 615-b on previously-reserved but not signaled resources (indicated from higher layer) so that the first UE 115-a may still transmit the TB(s) with up to a defined quantity of retransmission times.

Reference will again be made to the wireless communications system 300 illustrated in FIG. 3. In some aspects, upon identifying a conflict between the first message 320-a (e.g., V2X message) to be transmitted by the first modem 310-a and the second message 320-b (e.g., DSRC message) to be transmitted by the second modem 310-b, the first UE 115-a may be configured to compare priorities associated with the first message 320-a (e.g., V2X message) and the second message 320-b (e.g., DSRC message).

In some cases, the first UE 115-a may be configured to prioritize DSRC communications over V2X communications in order to transmit BSMs via DSRC. Comparatively, in other cases, the V2X communications may be prioritized over DSRC messages. Further, different types of V2X and DSRC messages may be associated with different priorities. In some cases, the first UE 115-a may be configured to drop the packet associated with the lower priority if both priorities (e.g., priorities of both the V2X packet/message and the DSRC packet/message) are known to the RF components associated with the respective modems 310 with sufficient time to make the drop decision.

In the context of conflict between the first and second RATs (e.g., if the first message 320-a associated with the first RAT overlaps in time with the second message 320-b associated with the second RAT), if the priorities of the respective messages 320 are known to the respective RATs (e.g., known at the modems 310) at the first UE 115-a at a time that is T msec prior to the start of the earliest of the two messages 320 (where T≤4 and is based on UE 115 implementation), then the first UE 115-a may be configured to transmit only the message 320 of the RAT with the highest priority. Further, the first UE 115-a may be configured to drop the message 320 associated with the RAT of the lower priority (e.g., refrain from performing the transmission in the selected/reserved resources), and generate a NACK to a MAC layer associated with the modem 310 of the dropped message 320. Such behavior by the first UE 115-a (e.g., transmitting the higher-priority message, and dropping transmission of the lower-priority message 320) may be determined by the SCI formats scheduling the respective messages, indicated by higher layers in case of a S-SS/PSBCH block or a sidelink synchronization signal using E-UTRA radio access, or defined by relevant standards associated with the wireless communications system 300.

Upon identifying the conflict and evaluating the relative priorities, the first UE 115-a may be configured to drop one of the first message 320-a (e.g., V2X message) or the second message 320-b (e.g., DSRC message), and may transmit the other message 320. For example, the first UE 115-a may drop transmission the first message 320-a (e.g., refrain from performing the first message 320-a within the originally scheduled resources) based on identifying the conflict between the first message 320-a and the second message 320-b, and may transmit the second message 320-b using the originally selected/determined resources. Moreover, the first UE 115-a may drop transmission of the first message 320-a (e.g., drop the V2X message) based on determining that the second message 320-b (e.g., DSRC message) has a higher priority as compared to the first message 320-a. Examples of when certain messages 320 are dropped compared to others are shown and described with reference to FIG. 5.

In cases where the first message 320-a associated with the first RAT is dropped, RF components associated with the first modem 310-a may communicate, to the first modem 310-a (e.g., baseband component), an additional message that indicates a first message retransmission 325 based on the transmission of the first message 320-a being dropped. In other words, the RF components may indicate for the first modem 310-a to trigger retransmission of the first message 320-a (e.g., V2X message) that was dropped, where the retransmission 325 illustrated in FIG. 3 illustrates a retransmission of the first message 320-a in the event the first message 320-a is dropped.

The RF components may communicate the indication of the retransmission 325 of the first message 320-a even in the absence of receipt of a feedback message from the second UE 115-b responsive to the dropped first message 320-a. In other words, the RF components may trigger the retransmission 325 even in cases where the first UE 115-a does not receive a NACK message communicated to the first modem 310-a (e.g., baseband component) via a MAC layer that would trigger retransmission 325 of the dropped message 320-a in the HARQ-based feedback mechanism of the V2X RAT.

In some aspects, the additional message communicated from the RF components to the first modem 310-a may indicate one or more parameters associated with the first message retransmission 325 (e.g., parameters that will be used for the retransmission 325 of the first message 320-a). Parameters of the first message retransmission 325 that may be indicated at may include, but are not limited to, an RV identifier associated with the first message retransmission 325, a second set of resources associated with the first message retransmission 325, or both.

Subsequently, the first UE 115-a (e.g., first modem 310-a, baseband component), may identify or select a second set of resources that will be used for the first message retransmission 325 (e.g., second set of resources that will be used to perform the retransmission 325 of the first message 320-a). The first UE 115-a may identify/select the resources for the retransmission 325 based on receiving the control message 315, identifying the second message 320-b, identifying the existence of the conflict between the messages 320, comparing the relative priorities of the messages 320, dropping transmission of the first message 320-a, communicating the drop indication from the RF components to the first modem 310-a, or any combination thereof.

In some cases, the first RAT may include dedicated resources that are used for retransmissions (e.g., retransmission 325) of dropped messages 320. That is, upon dropping a V2X message (e.g., first message 320-a) scheduled within a first resource, the first UE 115-a may be configured to perform retransmissions 325 of the V2X message within a second resource that is associated with (e.g., SPSed with) the first resource. In other words, the resources for the retransmission 325 may be SPSed with the resources for the first message 320-a. As such, in some cases, the drop indication message communicated to the modem 310-a may indicate the pre-configured retransmission resources and/or new resources that are to be used for the retransmission 325 of the first message 320-a.

Accordingly, in some cases, the first UE 115-a may select the second set of resources for the retransmission 325 based on a relationship (e.g., SPS configuration) between the first, original set of resources for the first message 320-a and the second set of resources for the retransmission 325. In other cases, the drop indication message communicated to the first modem 310-a may indicate the second set of resources that are to be used for the first message retransmission 325.

In some cases, BSM applications may be periodic, in which BSM messages are transmitted in accordance with a determined periodicity P (e.g., P=100 ms). A DSRC RAT may include asynchronized system where CCA usually takes up to several hundreds of microseconds to complete. Moreover, a V2X RAT (e.g., NR-V2X) may include a synchronized system where the slot length may be approximately 0.5 ms (e.g., 600 μs). As such, in-device transmission collisions may be repeated when DSRC traffic is periodic, and V2X resource reservations are SPSed. In other words, in cases where the first message 320-a (e.g., V2X message) and the second message 320-b (e.g., DSRC message) are associated with periodic resource sets/periodic transmissions, the first UE 115-a may experience repeating collisions between the respective RATs.

Accordingly, in some implementations, to avoid consecutive collisions/dropped messages that may happen for periodic (e.g., SPSed) resources, upon receiving the drop indication message from the RF components, the first modem 310-a may be configured to perform resource reselection to select new resources that will be used for the retransmission 325. For example, upon receiving the drop indication message, the first modem 310-a may terminate the current reserved SPS resource, and randomly generate a new SPS counter, where the new SPS counter is used to select/identify new SPS resources for the retransmission 325 (and/or subsequent messages 320 and retransmissions 325). In such cases, the first UE 115-a (e.g., first modem 310-a) may perform the resource reselection and indicate the new resource reservation information to the second UE 115-b via an SCI message 330 (e.g., SCI-1).

In additional or alternative implementations, the modems 310 associated with the respective RATs at the first UE 115-a may be configured to mitigate in-device coexistence interference (e.g., reduce collisions between messages transmitted via the respective RATs) by exchanging coordination information (e.g., coordination messages 335) with one another.

In particular, as noted previously herein, V2X traffic may be periodic in some cases, where NR-V2X resource reservations are SPSed. In such cases, DSRC devices (e.g., second modem 310-b) may be configured to determine whether to freeze or delay CCA procedures for DSRC traffic based on coordination messages 335 received by the first modem 310-a. Coordination messages 335 exchanged between the respective modems 310 may include information associated with communications performed via the respective RATs, including resource reservation information (e.g., time and frequency domain information) for initial messages 320 and retransmissions performed via the respective RATs, reservation periodicity information (Pᵣₛᵥₚ) for resources associated with the respective RATs, SPS counter information (e.g., SPS counter indicating remaining number of SPS processes for current reservation) and the like.

For example, as noted previously herein, the first UE 115-a may receive, from the network entity 105-a, a control message 315 that indicates a first set of resources usable by the first UE 115-a for transmitting message 320 (e.g., first message 320-a) associated with a first RAT to the second UE 115-b. For example, the control message 320 may indicate a first set of V2X resources for transmitting V2X message 320 to the second UE 115-b.

Subsequently, the first UE 115-c may cause the first modem 310-a to output a coordination message 335 to the second modem 310-b. In some aspects, the coordination message 335 may indicate the first set of resources that are usable by the first RAT. In other words, the first V2X modem (e.g., first modem 310-a) may inform the DSRC modem (e.g., second modem 310-b) of resources that are to be used for V2X communications. For example, the coordination message 335 may indicate a set/list of slots or TTIs that are usable for transmitting V2X message 320, time and frequency domain resource reservation information for initial and/or retransmission(s), and the like.

The coordination message 335 may indicate additional or alternative parameters associated with the first RAT, including an indication of a periodicity associated with the first set of resources usable by the first RAT, an indication of one or more priorities associated with message 320 communicated via the first RAT, a periodicity associated the first set of resources usable by the first RAT (e.g., reservation periodicity Pᵣₛᵥₚ), an SPS counter associated with the first set of resources usable by the first RAT (e.g., SPS counter indicating remaining number of SPS processes for current reservation), and the like.

After receiving the coordination message 335, the second modem 310-b (e.g., DSRC modem) may be configured to freeze CCA for DSRC messages (e.g., second message 320-b) if the first modem 310-a is currently transmitting (or is about to transmit) a V2X. For example, the second modem 310-b may freeze a CCA counter during a transmission interval associated with messages performed by the first modem 310-a, and may resume the CCA counter after an end of the transmission interval. Additionally, or alternatively, the second modem 310-b (e.g., DSRC modem) may cancel the CCA procedure for the DSRC message(s), and reset/restart the CCA after an end of the V2X transmission.

In some cases, the second modem 310-b (e.g., DSRC modem) may be configured to also avoid PSFCH transmission occasions associated with feedback messages responsive to messages transmitted by the first modem 310-a. In other words, the second modem 310-b may be configured to select resources for messages 320 performed via the second RAT which avoid conflicts both with messages transmitted via the first RAT, as well as feedback messages responsive to the messages transmitted via the first RAT. For instance, the second modem 310-b may avoid PSFCH transmission occasions in two symbols of every N slot, where N is the PSFCH period {1, 2, 4}. Additionally, or alternatively, the second modem 310-b may utilize SCI-1 and SCI-2 decoding information in order to avoid conflicts on PSFCH occasions.

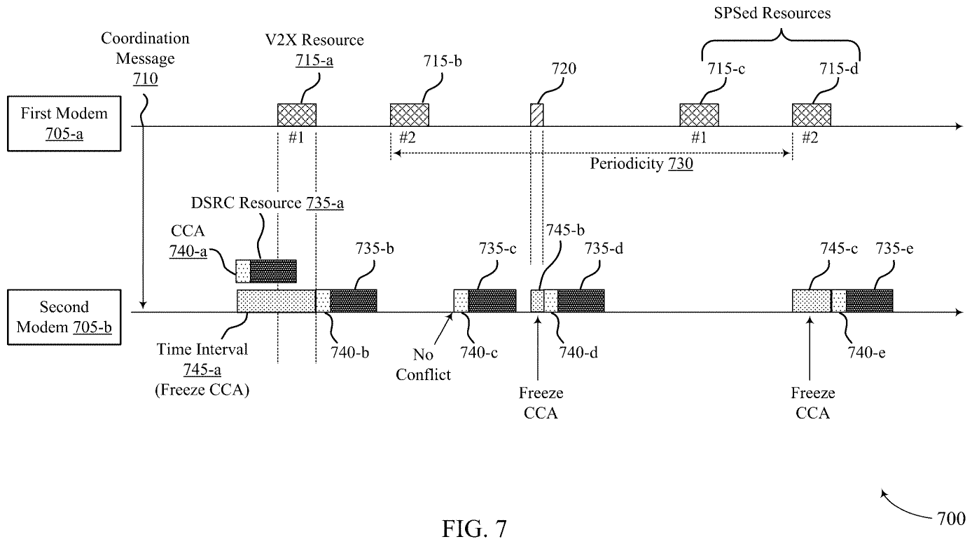

The use of coordination information exchanged between modems 310 to reduce collisions between RATs may be further shown and described with reference to FIG. 7.

FIG. 7 illustrates an example of a resource configuration 700 that supports techniques for mitigating adjacent channel coexistence interference in accordance with one or more aspects of the present disclosure. Aspects of the resource configuration 700 may implement, or be implemented by, aspects of wireless communications system 100, the network architecture 200, the wireless communications system 300, the radio front end configuration 400, the resource configuration 500, the resource configuration 600, or any combination thereof.

The resource configuration 700 illustrates communications performed by a first modem 705-a associated with a first RAT (e.g., V2X) and a second modem 705-b associated with a second RAT (e.g., DSRC). In this regard, the first modem 705-a and the second modem 705-b illustrated in FIG. 7 may include examples of the first modem 310-a and the second modem 310-b, respectively, as illustrated in FIG. 3.

In some cases, the first modem 705-a may communicate, to the second modem 705-b, a coordination message 710 indicating information associated with resources used for communications via the first RAT. For example, described previously herein, the coordination message 710 may indicate time and frequency domain information associated with V2X resources 715 (e.g., V2X resources 715-a, 715-b, 715-c, 715-d) used by the first modem 705-a for V2X messages. In some cases, the coordination message 710 may additionally indicate one or more periodicities 730 associated with the V2X resources 715 (e.g., reservation periodicity Pᵣₛᵥₚ), an SPS counter associated with the set of V2X resources 715, feedback resource 720 associated with the V2X resources 715, or any combination thereof.

The second modem 705-b may be configured to utilize information communicated via the coordination message 710 to avoid conflicts between V2X messages communicated via the V2X resources 715 and DSRC messages communicated via DSCR resources 735. In particular, in some implementations, the second modem 705-b may be configured to freeze a CCA procedure 740 if the first modem 705-a is transmitting (or is about to transmit) a V2X packet via a V2X resource. In particular, the second modem 705-b (e.g., DSRC modem) may be configured to avoid transmitting DSRC packets that would collide with V2X packets transmitted within V2X resources 715, where the V2X resources 715 may be defined by [v2xStart+j*P, v2xEnd+j*P], j∈[0, SPS_{counter}]. Further, the second modem 705-b may be configured to avoid transmitting DSRC packets that would interfere with feedback resources 720 for V2X messages (e.g., two feedback symbols in every four slots).

For example, as shown in FIG. 7, the second modem 705-b may freeze a CCA procedure 740-a for a DSRC resource 735-a during a time interval 745-a based on a DSRC packet within DSRC resource 735-a being expected to overlap with (e.g., collide with) a V2X packet within the V2X resource 715-a. In this regard, the second modem 705-b may freeze the CCA procedure 740-a during time interval 745-a, and may refrain from transmitting a packet within the DSRC resource 735-a. Following an end of the time interval 745-a (and after an end of the V2X resource 715-a), the second modem 705-b may resume (or restart) a CCA procedure 740-b, and may transmit a packet within the DSRC resource 735-b (after successful completion of the CCA procedure 740-b).

As shown in FIG. 7, the second modem 705-b may determine (based on the coordination message 710) that there is no conflict between the DSRC resource 735-c and the V2X resources 715, and may therefore perform a CCA procedure 740-c and transmit a packet within the DSRC resource 735-c (after successful completion of the CCA procedure 740-c).

Comparatively, the second modem 705-b may identify a feedback resource 720 associated with the V2X resources 715 based on the coordination message 710. As such, the second modem 705-b may freeze a CCA procedure 740-d during a time interval 745-b that overlaps with the feedback resource 720. In other words, the second modem 705-b may freeze the CCA procedure 740-d when a collision is expected with V2X feedback symbols. In this example, following an end of the time interval 745-b (e.g., after an end of the feedback resource 720), the second modem 705-b may resume (or restart) the CCA procedure 740-d, and may transmit a packet within the DSRC resource 735-d (after successful completion of the CCA procedure 740-d).

Similarly, the second modem 705-b may identify SPSed V2X resources 715-c and 715-d based on the coordination message 710, and may freeze a CCA procedure 740-e during a time interval 745-c that overlaps with the V2X resource 715-d. In this example, following an end of the time interval 745-c (e.g., after an end of the V2X resource 715-d), the second modem 705-b may resume (or restart) the CCA procedure 740-e, and may transmit a packet within the DSRC resource 735-e (after successful completion of the CCA procedure 740-e).

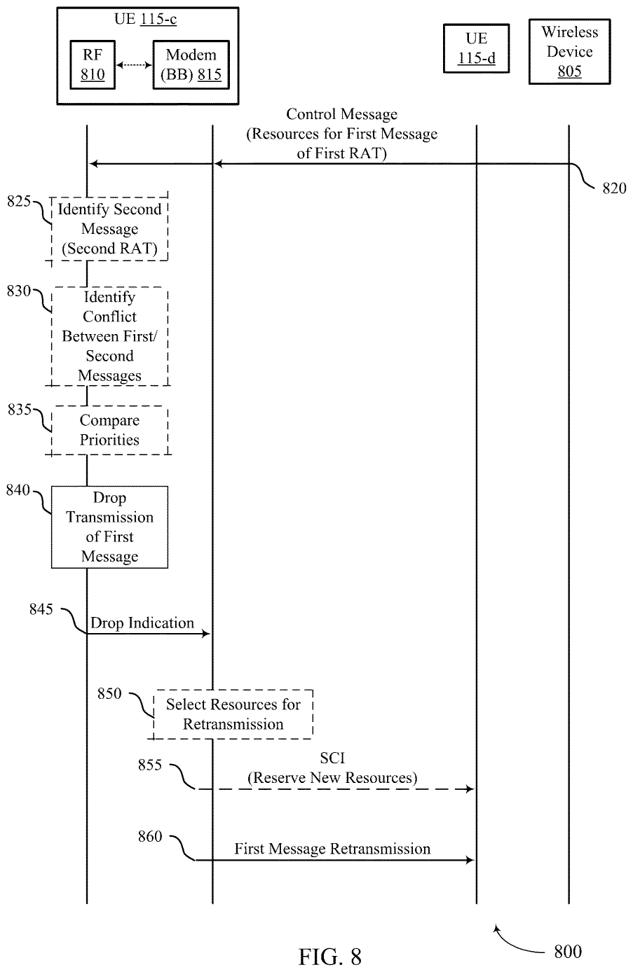

FIG. 8 illustrates an example of a process flow 800 that supports techniques for mitigating adjacent channel coexistence interference in accordance with one or more aspects of the present disclosure. Aspects of the process flow 800 may implement, or be implemented by, aspects of wireless communications system 100, the network architecture 200, the wireless communications system 300, the radio front end configuration 400, the resource configuration 500, the resource configuration 600, the resource configuration 700, or any combination thereof. For example, the process flow 800 illustrates signaling within a UE 115-c that enables the UE 115-c to autonomously trigger retransmission of a dropped message, as described previously herein.

The process flow 800 includes a first UE 115-c, a second UE 115-d, and a wireless device 805, which may be examples of wireless devices as described herein. For example, the first UE 115-c, the second UE 115-d, and the wireless device 805 illustrated in FIG. 8 may include examples of the first UE 115-a, the second UE 115-b, and the network entity 105-a, respectively, as illustrated in FIG. 3.

In some aspects, as shown in FIG. 8, the first UE 115-c may include a modem 815 (e.g., baseband component) and RF components 810 (e.g., Tx chain). In some cases, the first UE 115-c may include an example of a dual-radio device that is able to communicate according to multiple RATs, such as a V2X RAT (e.g., LTE-V2X, NR-V2X) and a DSRC RAT (e.g., Wi-Fi, or other 802.11p RAT). In such cases, the modem 815 and the RF components 810 illustrated in FIG. 8 may be associated with a V2X RAT.

In some examples, the operations illustrated in process flow 800 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 820, the first UE 115-c may receive, from the wireless device 805, a control message that indicates a set of resources usable by the first UE 115-c for transmitting messages associated with a first RAT to the second UE 115-d. For example, the control message may indicate a set of V2X resources for transmitting a V2X message to the second UE 115-d. In this example, retransmissions of the scheduled V2X message may be triggered based on feedback messages (e.g., NACK messages) received responsive to the V2X message. That is, the first RAT (e.g., V2X) may include a HARQ-based RAT in which retransmissions are triggered based on reception of NACK messages communicated to the modem 815/baseband component of the first UE 115-c via a MAC layer (e.g., after transmitting a V2X message, the first UE 115-c may retransmit the V2X message if it receives a NACK message responsive to the V2X message).

At 825, the first UE 115-c may identify a second message scheduled for transmission via a second RAT. For example, the first UE 115-c may identify a DSRC message (e.g., Wi-Fi messages) that is scheduled to be transmitted by the first UE 115-c (e.g., Wi-Fi message scheduled to be transmitted by another modem 815 associated with Wi-Fi communications).

In some aspects, the first UE 115-c may identify the second message by evaluating a message buffer associated with the second RAT, as shown and described in FIG. 5. In particular, the first UE 115-c may evaluate the message buffer of the second RAT at a status check point that is some time prior to a start of the set of resources usable for the first message (e.g., status check point prior to the scheduled V2X message), as shown in FIG. 5. In some aspects, the time interval between the status check point and the start of the V2X message may be based on one or more processing capabilities of the first UE 115-c.

At 830, the first UE 115-c may identify a conflict between the first message of the first RAT (e.g., V2X message) and the second message of the second RAT (e.g., DSRC message). The first UE 115-c may identify the conflict based on receiving the control message at 820, identifying the second message at 825, or both.

For example, the first UE 115-c may identify the conflict based on determining that the first message (e.g., V2X message) starts before an end of a CCA procedure associated with the second message (e.g., DSRC message). By way of another example, the first UE 115-c may identify a conflict based on identifying that the first message (e.g., V2X message) and the second message (e.g., DSRC message) are scheduled to be transmitted in overlapping time resources. In some aspects, identification of the conflict may be performed at the status check point that is determined relative to the first message. Identification of conflicts between the first and second messages is described in further detail with respect to FIG. 5.

At 835, the first UE 115-c may compare priorities associated with the first message (e.g., V2X message) and the second message (e.g., DSRC message), by comparing relative priorities of the first and second RATs, or both. In some aspects, the first UE 115-c may perform the comparison(s) at 835 based on receiving the control message at 820, identifying the second message at 825, identifying the existence of a conflict at 830, or any combination thereof.

In some cases, the first UE 115-c may be configured to prioritize DSRC communications over V2X communications in order to transmit BSMs via DSRC. Comparatively, in other cases, the V2X communications may be prioritized over DSRC messages. Further, different types of V2X and DSRC messages may be associated with different priorities. In some cases, the first UE 115-c may be configured to drop the packet associated with the lower priority if both priorities (e.g., priorities of both the V2X packet/message and the DSRC packet/message) are known to the RF components 810 with sufficient time to make the drop decision.

At 840, the first UE 115-c may drop one of the first message (e.g., V2X message) or the second message (e.g., DSRC message). The first UE 115-c may drop one of the messages at 840 based on receiving the control message at 820, identifying the second message at 825, identifying the existence of a conflict at 830, performing the comparison(s) at 835, or any combination thereof.

For example, the first UE 115-c may drop transmission the first message (e.g., refrain from performing the first message within the originally scheduled resources) based on identifying the conflict between the first message and the second message. Moreover, the first UE 115-c may drop transmission of the first message (e.g., drop the V2X message) based on determining that the second message (e.g., DSRC message) has a higher priority as compared to the first message. Examples of when certain messages are dropped compared to others are further shown and described with reference to FIG. 5.

As noted previously herein, V2X communications may be associated with HARQ-based feedback mechanisms, in which feedback messages for V2X messages are triggered based on reception of HARQ feedback messages. However, in the event the first UE 115-c drops the first message (e.g., V2X message), the second UE 115-d may not transmit a NACK message (as the second UE 115-d never received any indication of the first message). As a result, in some wireless communications systems, the first UE 115-c would not receive a feedback message that would trigger retransmission of the dropped message (as the modem 815 may not be aware of the dropped message). Comparatively, aspects of the present disclosure are directed to techniques that may enable the first UE 115-c to autonomously trigger retransmission of the dropped message, even in cases where the first UE 115-c does not receive a feedback message that would otherwise trigger retransmission. This may be further shown and described with reference to step 845.

At 845, the RF components 810 may communicate, to the modem 815 (e.g., baseband component), an additional message that indicates a first message retransmission based on the transmission of the first message being dropped at 840. In other words, the RF components 810 may indicate for the modem to trigger retransmission of the first message (e.g., V2X message) that was dropped at 840. Moreover, the RF components 810 may communicate the indication of the retransmission at 845 even in the absence of receipt of a feedback message from the second UE 115-d responsive to the dropped first message. In other words, the RF components 810 may trigger retransmission even in cases where the first UE 115-c does not receive a NACK message communicated to the modem 815 (e.g., baseband component) via a MAC layer that would trigger retransmission of the dropped message in the HARQ-based feedback mechanism of the V2X RAT.

In some aspects, the additional message communicated to the modem 815 at 845 may indicate one or more parameters associated with the first message retransmission (e.g., parameters that will be used for retransmitting the first message). Parameters of the first message retransmission that may be indicated at 845 may include, but are not limited to, an RV identifier associated with the first message retransmission, a second set of resources associated with the first message retransmission, or both.

At 850, the first UE 115-c (e.g., modem 815, baseband component), may identify or select a second set of resources that will be used for the first message retransmission (e.g., second set of resources that will be used to perform the retransmission of the first message). The first UE 115-c may identify/select the resources for the retransmission at 850 based on receiving the control message at 820, identifying the second message at 825, identifying the existence of a conflict at 830, performing the comparison(s) at 835, dropping transmission of the first message at 840, communicating the drop indication at 845, or any combination thereof.

In some cases, the first RAT may include dedicated resources that are used for retransmissions of dropped messages. That is, upon dropping a V2X message scheduled within a first resource, the first UE 115-c may be configured to perform retransmissions of the V2X message within a second resource that is associated with (e.g., SPSed with) the first resource. As such, in some cases, the message communicated at 845 may indicate the pre-configured retransmission resources and/or new resources that are to be used for the retransmission of the first message.

Accordingly, in some cases, the first UE 115-c may select the second set of resources for the retransmission based on a relationship (e.g., SPS configuration) between the first, original set of resources for the first message and the second set of resources for the retransmission. In other cases, the message at 845 may indicate the second set of resources that are to be used for the first message retransmission.

By way of another example, in some cases, the first UE 115-c (e.g., the modem 815) may select a new set of resources for the retransmission that are different from a set of resources previously allocated/determined for the retransmission. In other words, in cases where an SPS configuration indicates a set of retransmission resources, the first UE 115-c may nonetheless select a different set of retransmission resources that will be used to retransmit the dropped first message. In some cases, the first UE 115-c may select a new set of resources to avoid multiple dropped transmissions, such as in cases where both the first and second RATs are associated with overlapping periodic resource sets.

For instance, in order to avoid multiple dropped transmissions, the first UE 115-c (e.g., the modem 815 or baseband component) may generate a new SPS counter based on the conflict/drop indication, and may select a new set of resources that will be used for retransmitting the first message based on the new SPS counter.

At 855, the first UE 115-c (e.g., modem 815) may transmit an SCI message to the second UE 115-d, where the SCI message indicates the set of resources that will be used to perform the first message retransmission. In this regard, the first UE 115-c may transmit the SCI message at 855 based on receiving the control message at 820, identifying the second message at 825, identifying the existence of a conflict at 830, performing the comparison(s) at 835, dropping transmission of the first message at 840, communicating the drop indication at 845, selecting the resources for the retransmission at 850, or any combination thereof.

At 860, the first UE 115-c (e.g., modem 815, baseband component) may perform the first message retransmission. In other words, the first UE 115-c may retransmit the first message (e.g., V2X message) which was dropped at 835. In particular, the first UE 115-c may transmit the first message retransmission in accordance with the one or more parameters indicated at 845, and within the set of retransmission resources identified/selected at 850 (and indicated to the second UE 115-d at 855).

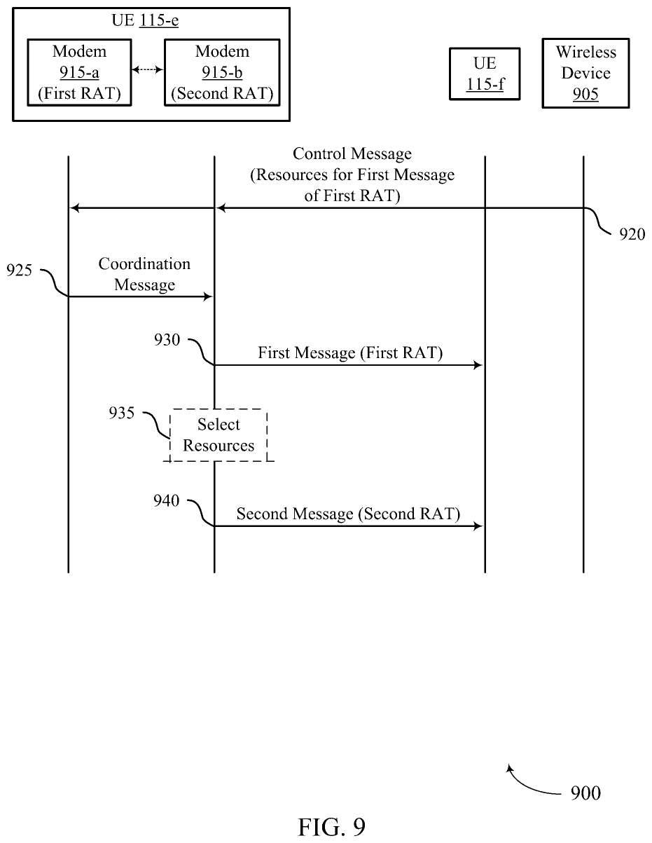

FIG. 9 illustrates an example of a process flow 900 that supports techniques for mitigating adjacent channel coexistence interference in accordance with one or more aspects of the present disclosure. Aspects of the process flow 900 may implement, or be implemented by, aspects of wireless communications system 100, the network architecture 200, the wireless communications system 300, the radio front end configuration 400, the resource configuration 500, the resource configuration 600, the resource configuration 700, the process flow 800, or any combination thereof. For example, the process flow 900 illustrates coordination signaling between modems of a UE 115-e that is used to mitigate in-device coexistence interference, as described previously herein.

The process flow 900 includes a first UE 115-e, a second UE 115-f, and a wireless device 905, which may be examples of wireless devices as described herein. For example, the first UE 115-e, the second UE 115-f, and the wireless device 905 illustrated in FIG. 9 may include examples of the first UE 115-a, the second UE 115-b, and the network entity 105-a, respectively, as illustrated in FIG. 3. Moreover, the first UE 115-e, the second UE 115-f, and the wireless device 905 illustrated in FIG. 9 may include examples of the first UE 115-c, the second UE 115-d, and the wireless device 805, respectively, as illustrated in FIG. 9.

In some aspects, the first UE 115-e may include a dual-radio device that is configured to communicate according to multiple different RATs. For example, as shown in FIG. 9, the first UE 115-e may include a first modem 915-a associated with a first RAT (e.g., V2X RAT), and a second modem 915-b associated with a second RAT (e.g., DSRC RAT, Wi-Fi, or other 802.11p RAT). As described previously herein, the respective modems 915 may include separate RF chains, and/or may share one or more RF components.

In some examples, the operations illustrated in process flow 900 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 920, the first UE 115-e may receive, from the wireless device 905, a control message that indicates a first set of resources usable by the first UE 115-e for transmitting messages associated with a first RAT to the second UE 115-f. For example, the control message may indicate a first set of V2X resources for transmitting V2X messages to the second UE 115-f.

At 925, the first UE 115-c may cause the first modem to output a coordination message to the second modem 915-b. In some aspects, the coordination message may indicate the first set of resources that are usable by the first RAT. In other words, the first V2X modem (e.g., first modem 915-a) may inform the DSRC modem (e.g., second modem 915-b) of resources that are to be used for V2X communications. For example, the coordination message may indicate a set/list of slots or TTIs that are usable for V2X messages, time and frequency domain resource reservation information for initial and/or retransmission(s), and the like.

The coordination message may indicate additional or alternative parameters associated with the first RAT, including an indication of a periodicity associated with the first set of resources usable by the first RAT, an indication of one or more priorities associated with messages communicated via the first RAT, a periodicity associated with the first set of resources usable by the first RAT (e.g., reservation periodicity Pᵣₛᵥₚ), an SPS counter associated with the first set of resources usable by the first RAT (e.g., SPS counter indicating remaining number of SPS processes for current reservation), and the like.

While FIG. 9 shows and describes coordination messages being communicated from the first modem 915-a to the second modem 915-b, this is only for illustrative purposes, and is not to be regarded as a limitation of the present disclosure, unless noted otherwise herein. In particular, in some implementations, the modems 915-a, 915-b may both exchange coordination messages with one another to help mitigate in-device coexistence interference.

At 930, the first UE 115-e (e.g., first modem 915-a) may transmit one or more messages to the second UE 115-f via the first RAT. In particular, the first UE 115-e may transmit the one or more messages via the first RAT within the first set of resources indicated via the control message at 920. Moreover, in some cases, the first UE 115-c may transmit the message(s) via the first RAT at 930 based on outputting the coordination message to the second modem 915-b at 925.

At 935, the first UE 115-c may select, using the second modem 915-b, a second set of resources that will be used to perform communications via the second RAT. The second modem 915-b may select a set of resources based on the coordination message at 935. In particular, the second modem 915-b may be configured to select a second set of resources that do not overlap or conflict with the first set of resources associated with the first RAT (which were indicated via the coordination message at 925). As such, the second modem 915-b may select the second set of resources for the second RAT based on the information/parameters indicated via the coordination message, such as the periodicity of the resources of the first RAT, priorities of the messages of the first RAT, an SPS counter associated with the resources of the first RAT, and the like.

Moreover, the second modem 915-b may be configured to select a second set of resources that do not overlap or conflict with a third set of resources that are used for feedback by the first RAT. In other words, the second modem 915-b may select resources that do not conflict with resources usable by the first UE 115-e for transmitting V2X messages, or with resources usable by the first UE 115-e for receiving V2X feedback messages.

At 940, the first UE 115-e (e.g., second modem 915-b) may transmit one or more messages to the second UE 115-f via the second RAT. In particular, the first UE 115-e may transmit the one or more messages via the second RAT within the second set of resources that were identified/selected at 935.

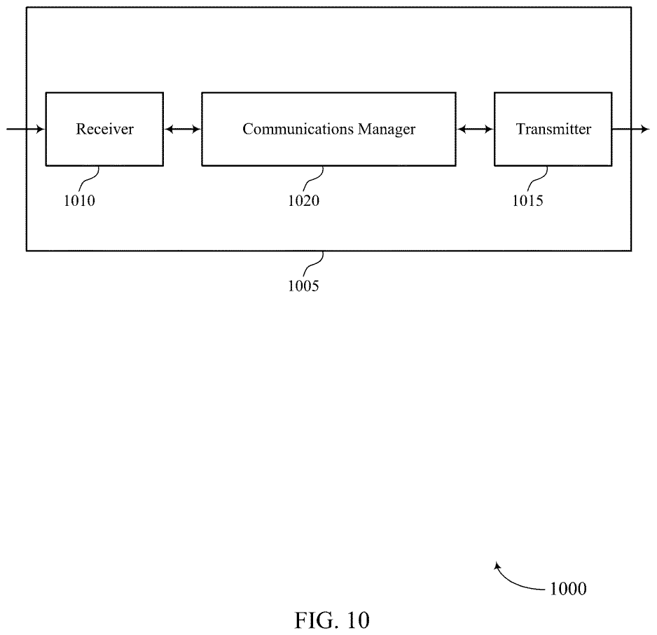

FIG. 10 illustrates a block diagram 1000 of a device 1005 that supports techniques for mitigating adjacent channel coexistence interference in accordance with one or more aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for mitigating adjacent channel coexistence interference). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for mitigating adjacent channel coexistence interference). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of techniques for mitigating adjacent channel coexistence interference as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a first UE in accordance with examples as disclosed herein. For example, the communications manager 1020 may be configured as or otherwise support a means for receiving, from a wireless device, first control information that indicates a first set of resources for transmission of at least a first message associated with a first RAT to a second UE. The communications manager 1020 may be configured as or otherwise support a means for dropping transmission of the first message based on identification of a conflict between the first set of resources associated with the first message scheduled for transmission by the first UE via the first RAT and a second set of resources associated with a second message scheduled for transmission by the first UE via a second RAT different from the first RAT. The communications manager 1020 may be configured as or otherwise support a means for communicating, to a modem associating with the first RAT at the first UE, second control information that indicates a retransmission of the first message based on an absence of receipt of a feedback message from the second UE responsive to the dropped first message and on the transmission of the first message being dropped. The communications manager 1020 may be configured as or otherwise support a means for transmitting the retransmission of the first message based on the second control information.

Additionally, or alternatively, the communications manager 1020 may support wireless communication at a first UE in accordance with examples as disclosed herein. For example, the communications manager 1020 may be configured as or otherwise support a means for receiving, from a wireless device, first control information that indicates a first set of resources for transmission of one or more messages associated with a first RAT to a second UE. The communications manager 1020 may be configured as or otherwise support a means for outputting, via a first modem associating with the first RAT to a second modem associated with a second RAT, a coordination message that indicates the first set of resources associated with the first RAT. The communications manager 1020 may be configured as or otherwise support a means for transmitting, via the first modem associated with the first RAT, a first message within the first set of resources, where the first message is transmitted based on the coordination message. The communications manager 1020 may be configured as or otherwise support a means for transmitting, via the second modem associated with the second RAT, a second message within a second set of resources selected based on the coordination message that indicates the first set of resources.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques to reduce in-device coexistence interference (e.g., adjacent channel coexistence interference) within dual-radio devices. In particular, aspects of the present disclosure may enable dual-radio devices to drop messages associated with one RAT in order to avoid in-device coexistence interference with messages transmitted via a second RAT. Moreover, techniques described herein may enable the dual-radio devices to autonomously trigger retransmissions of dropped messages using signaling between components of a modem associated with the dropped transmissions. Further, techniques described herein may enable modems associated with different RATs of dual-radio devices to exchange coordination messages with one another, where the coordination messages enable the modems to select resources that will reduce or eliminate in-device coexistence interference between the respective RATs. As such, techniques described herein may reduce in-device coexistence interference (e.g., adjacent channel coexistence interference) within the wireless communications system, and lead to more efficient and reliable communications.

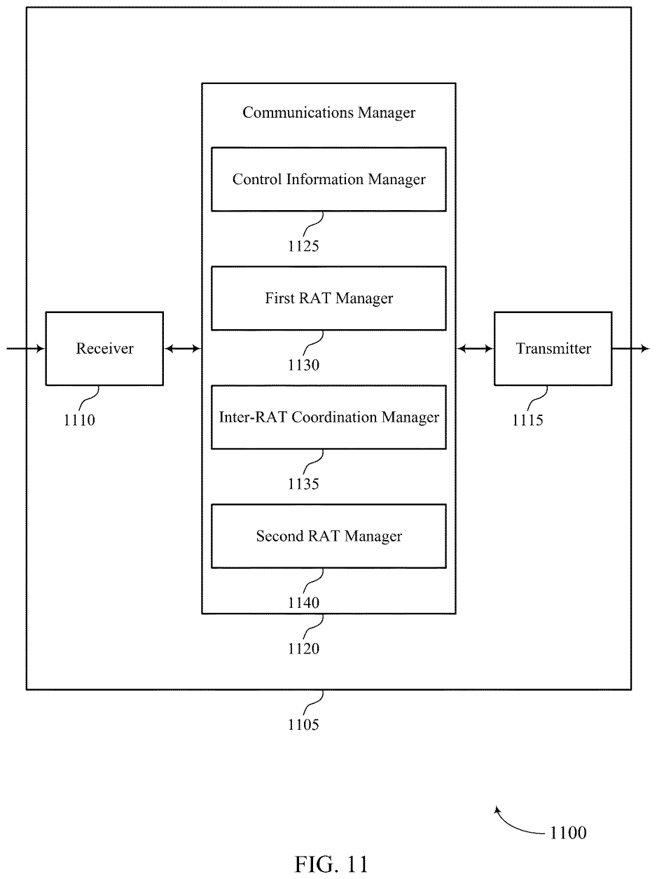

FIG. 11 illustrates a block diagram 1100 of a device 1105 that supports techniques for mitigating adjacent channel coexistence interference in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for mitigating adjacent channel coexistence interference). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for mitigating adjacent channel coexistence interference). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of techniques for mitigating adjacent channel coexistence interference as described herein. For example, the communications manager 1120 may include a control information manager 1125, a first RAT manager 1130, an inter-RAT coordination manager 1135, a second RAT manager 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a first UE in accordance with examples as disclosed herein. The control information manager 1125 may be configured as or otherwise support a means for receiving, from a wireless device, first control information that indicates a first set of resources for transmission of at least a first message associated with a first RAT to a second UE. The first RAT manager 1130 may be configured as or otherwise support a means for dropping transmission of the first message based on identification of a conflict between the first set of resources associated with the first message scheduled for transmission by the first UE via the first RAT and a second set of resources associated with a second message scheduled for transmission by the first UE via a second RAT different from the first RAT. The first RAT manager 1130 may be configured as or otherwise support a means for communicating, to a modem associated with the first RAT at the first UE, second control information that indicates a retransmission of the first message based on an absence of receipt of a feedback message from the second UE responsive to the dropped first message and on the transmission of the first message being dropped. The first RAT manager 1130 may be configured as or otherwise support a means for transmitting the retransmission of the first message based on the second control information.

Additionally, or alternatively, the communications manager 1120 may support wireless communication at a first UE in accordance with examples as disclosed herein. The control information manager 1125 may be configured as or otherwise support a means for receiving, from a wireless device, first control information that indicates a first set of resources for transmission of one or more messages associated with a first RAT to a second UE. The inter-RAT coordination manager 1135 may be configured as or otherwise support a means for outputting, via a first modem associated with the first RAT to a second modem associated with a second RAT, a coordination message that indicates the first set of resources associated with the first RAT. The first RAT manager 1130 may be configured as or otherwise support a means for transmitting, via the first modem associated with the first RAT, a first message within the first set of resources, where the first message is transmitted based on the coordination message. The second RAT manager 1140 may be configured as or otherwise support a means for transmitting, via the second modem associated with the second RAT, a second message within a second set of resources selected based on the coordination message that indicates the first set of resources.

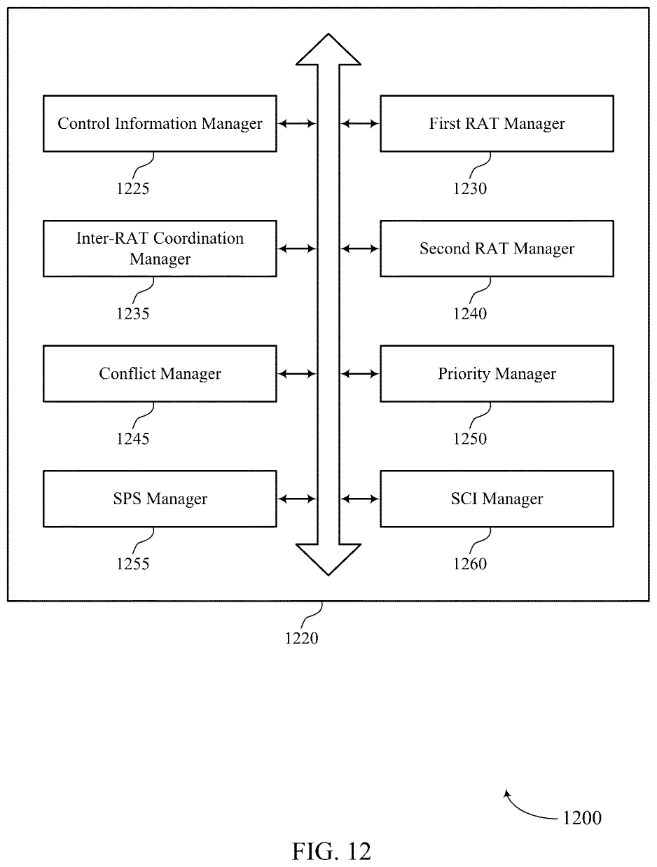

FIG. 12 illustrates a block diagram 1200 of a communications manager 1220 that supports techniques for mitigating adjacent channel coexistence interference in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for mitigating adjacent channel coexistence interference as described herein. For example, the communications manager 1220 may include a control information manager 1225, a first RAT manager 1230, an inter-RAT coordination manager 1235, a second RAT manager 1240, a conflict manager 1245, a priority manager 1250, an SPS manager 1255, an SCI manager 1260, or any combination thereof. Each of these components may communicate, directly or indirectly, with one another (e.g., via one or more buses).

The communications manager 1220 may support wireless communication at a first UE in accordance with examples as disclosed herein. The control information manager 1225 may be configured as or otherwise support a means for receiving, from a wireless device, first control information that indicates a first set of resources for transmission of at least a first message associated with a first RAT to a second UE. The first RAT manager 1230 may be configured as or otherwise support a means for dropping transmission of the first message based on identification of a conflict between the first set of resources associated with the first message scheduled for transmission by the first UE via the first RAT and a second set of resources associated with a second message scheduled for transmission by the first UE via a second RAT different from the first RAT. In some examples, the first RAT manager 1230 may be configured as or otherwise support a means for communicating, to a modem associated with the first RAT at the first UE, second control information that indicates a retransmission of the first message based on an absence of receipt of a feedback message from the second UE responsive to the dropped first message and on the transmission of the first message being dropped. In some examples, the first RAT manager 1230 may be configured as or otherwise support a means for transmitting the retransmission of the first message based on the second control information.

In some examples, the first UE is configured to perform retransmissions of the first message based on receipt of one or more feedback messages associated with the first message.

In some examples, the second RAT manager 1240 may be configured as or otherwise support a means for identifying that the second message is scheduled for transmission via the second RAT based on an evaluation of a message buffer associated with the second RAT at a status check point that is prior to a start of the first set of resources associated with the first message, where the conflict is identified based on identifying that the second message is scheduled for transmission.

In some examples, a time interval between the status check point and the start of the first set of resources usable for the first message is based on one or more processing capabilities of the UE.

In some examples, the conflict manager 1245 may be configured as or otherwise support a means for identifying the conflict between the first set of resources associated with the first message and the second set of resources associated with the second message based on a start of the first set of resources associated with the first message occurring prior to an end of a CCA procedure associated with the second message in a time domain, where the transmission of the first message is dropped based on identification of the conflict.

In some examples, the control information manager 1225 may be configured as or otherwise support a means for indicating, via the second control information, one or more parameters associated with the retransmission of the first message, where the retransmission of the first message is performed in accordance with the one or more parameters.

In some examples, the one or more parameters associated with the retransmission of the first message include an RV identifier associated with the retransmission of the first message, a second set of resources associated with the retransmission of the first message, or both.

In some examples, the first RAT manager 1230 may be configured as or otherwise support a means for identifying a third set of resources reserved for retransmissions of the first message based on the first control information, where the retransmission of the first message is transmitted within the third set of resources.

In some examples, the second control information includes a NACK message communicated to the modem via a MAC layer.

In some examples, the first RAT manager 1230 may be configured as or otherwise support a means for selecting, via the modem, a third set of resources for the retransmission of the first message based on identification of the conflict and based on the first set of resources associated with the first message and the second set of resources associated with the second message including periodic resource sets, where the retransmission of the first message is transmitted within the third set of resources.

In some examples, the first set of resources associated with the first message is associated with a first SPS counter, and the SPS manager 1255 may be configured as or otherwise support a means for generating a second SPS counter based on identifying the conflict and based on the first set of resources and the second set of resources including periodic resource sets, where the third set of resources is selected based on the second SPS counter.

In some examples, the SCI manager 1260 may be configured as or otherwise support a means for transmitting an SCI that indicates the third set of resources based on selection of the third set of resources, where the retransmission of the first message is transmitted based on the SCI.

In some examples, the priority manager 1250 may be configured as or otherwise support a means for comparing a first priority associated with the first message, the first RAT, or both, and a second priority associated with the second message, the second RAT, or both, the second priority greater than the first priority, where the transmission of the first message is dropped based on the comparison.

In some examples, the first RAT includes an LTE RAT, a 4G RAT, a 5G RAT, an NR access technology, a 6G RAT, or any combination thereof. In some examples, the second RAT includes a Wi-Fi access technology, a DSRC access technology, or both.

In some examples, the first RAT includes an LTE-V2X RAT, an NR-V2X RAT, or both.

Additionally, or alternatively, the communications manager 1220 may support wireless communication at a first UE in accordance with examples as disclosed herein. In some examples, the control information manager 1225 may be configured as or otherwise support a means for receiving, from a wireless device, first control information that indicates a first set of resources for transmission of one or more messages associated with a first RAT to a second UE. The inter-RAT coordination manager 1235 may be configured as or otherwise support a means for outputting, via a first modem associated with the first RAT to a second modem associated with a second RAT, a coordination message that indicates the first set of resources associated with the first RAT. In some examples, the first RAT manager 1230 may be configured as or otherwise support a means for transmitting, via the first modem associated with the first RAT, a first message within the first set of resources, where the first message is transmitted based on the coordination message. The second RAT manager 1240 may be configured as or otherwise support a means for transmitting, via the second modem associated with the second RAT, a second message within a second set of resources selected based on the coordination message that indicates the first set of resources.

In some examples, to support outputting the coordination message, the inter-RAT coordination manager 1235 may be configured as or otherwise support a means for outputting, via the coordination message, an indication of a periodicity associated with the first set of resources, where the second set of resources is selected based on the periodicity.

In some examples, to support outputting the coordination message, the inter-RAT coordination manager 1235 may be configured as or otherwise support a means for outputting, via the coordination message, an indication of a SPS counter associated with the first set of resources, where the second set of resources is selected based on the SPS counter.

In some examples, the second set of resources are further selected based on a third set of resources associated with feedback responsive to messages transmitted via the first set of resources.

In some examples, the first RAT includes an LTE RAT, a 4G RAT, a 5G RAT, an NR access technology, a 6G RAT, or any combination thereof. In some examples, the second RAT includes a Wi-Fi access technology, a DSRC access technology, or both.

In some examples, the first RAT includes an LTE-V2X RAT, an NR-V2X RAT, or both.

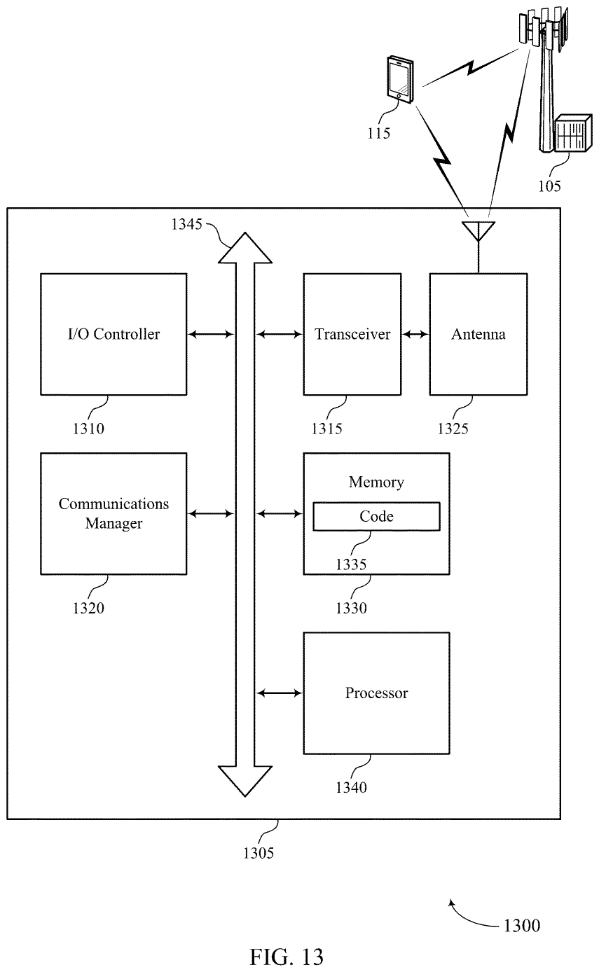

FIG. 13 illustrates a diagram of a system 1300 including a device 1305 that supports techniques for mitigating adjacent channel coexistence interference in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions.

The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting techniques for mitigating adjacent channel coexistence interference). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communication at a first UE in accordance with examples as disclosed herein. For example, the communications manager 1320 may be configured as or otherwise support a means for receiving, from a wireless device, first control information that indicates a first set of resources for transmission of at least a first message associated with a first RAT to a second UE. The communications manager 1320 may be configured as or otherwise support a means for dropping transmission of the first message based on identification of a conflict between the first set of resources associated with the first message scheduled for transmission by the first UE via the first RAT and a second set of resources associated with a second message scheduled for transmission by the first UE via a second RAT different from the first RAT. The communications manager 1320 may be configured as or otherwise support a means for communicating, to a modem associating with the first RAT at the first UE, second control information that indicates a retransmission of the first message based on an absence of receipt of a feedback message from the second UE responsive to the dropped first message and on the transmission of the first message being dropped. The communications manager 1320 may be configured as or otherwise support a means for transmitting the retransmission of the first message based on the second control information.

Additionally, or alternatively, the communications manager 1320 may support wireless communication at a first UE in accordance with examples as disclosed herein. For example, the communications manager 1320 may be configured as or otherwise support a means for receiving, from a wireless device, first control information that indicates a first set of resources for transmission of one or more messages associated with a first RAT to a second UE. The communications manager 1320 may be configured as or otherwise support a means for outputting, via a first modem associating with the first RAT to a second modem associated with a second RAT, a coordination message that indicates the first set of resources associated with the first RAT. The communications manager 1320 may be configured as or otherwise support a means for transmitting, via the first modem associated with the first RAT, a first message within the first set of resources, where the first message is transmitted based on the coordination message. The communications manager 1320 may be configured as or otherwise support a means for transmitting, via the second modem associated with the second RAT, a second message within a second set of resources selected based on the coordination message that indicates the first set of resources.

By including or configuring the communications manager 1320 in accordance with examples as described herein, the device 1305 may support techniques to reduce in-device coexistence interference (e.g., adjacent channel coexistence interference) within dual-radio devices. In particular, aspects of the present disclosure may enable dual-radio devices to drop messages associated with one RAT in order to avoid in-device coexistence interference with messages transmitted via a second RAT. Moreover, techniques described herein may enable the dual-radio devices to autonomously trigger retransmissions of dropped messages using signaling between components of a modem associated with the dropped transmissions. Further, techniques described herein may enable modems associated with different RATs of dual-radio devices to exchange coordination messages with one another, where the coordination messages enable the modems to select resources that will reduce or eliminate in-device coexistence interference between the respective RATs. As such, techniques described herein may reduce in-device coexistence interference (e.g., adjacent channel coexistence interference) within the wireless communications system, and lead to more efficient and reliable communications.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of techniques for mitigating adjacent channel coexistence interference as described herein, or the processor 1340 and the memory 1330 may be otherwise configured to perform or support such operations.

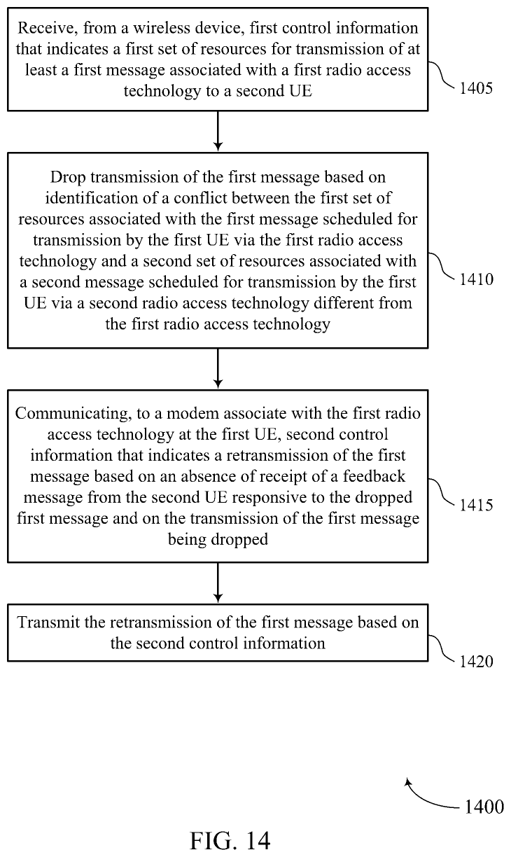

FIG. 14 illustrates a flowchart showing a method 1400 that supports techniques for mitigating adjacent channel coexistence interference in accordance with one or more aspects of the present disclosure. The operations of the method 1400 may be implemented by a UE or its components as described herein. For example, the operations of the method 1400 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1405, the method may include receiving, from a wireless device, first control information that indicates a first set of resources for transmission of at least a first message associated with a first RAT to a second UE. The operations of 1405 may be performed in accordance with examples as disclosed herein. In some examples, aspects of the operations of 1405 may be performed by a control information manager 1225 as described with reference to FIG. 12.

At 1410, the method may include dropping transmission of the first message based on identification of a conflict between the first set of resources associated with the first message scheduled for transmission by the first UE via the first RAT and a second set of resources associated with a second message scheduled for transmission by the first UE via a second RAT different from the first RAT. The operations of 1410 may be performed in accordance with examples as disclosed herein. In some examples, aspects of the operations of 1410 may be performed by a first RAT manager 1230 as described with reference to FIG. 12.

At 1415, the method may include communicating, to a modem associated with the first RAT at the first UE, second control information that indicates a retransmission of the first message based on an absence of receipt of a feedback message from the second UE responsive to the dropped first message and on the transmission of the first message being dropped. The operations of 1415 may be performed in accordance with examples as disclosed herein. In some examples, aspects of the operations of 1415 may be performed by a first RAT manager 1230 as described with reference to FIG. 12.

At 1420, the method may include transmitting the retransmission of the first message based on the second control information. The operations of 1420 may be performed in accordance with examples as disclosed herein. In some examples, aspects of the operations of 1420 may be performed by a first RAT manager 1230 as described with reference to FIG. 12.

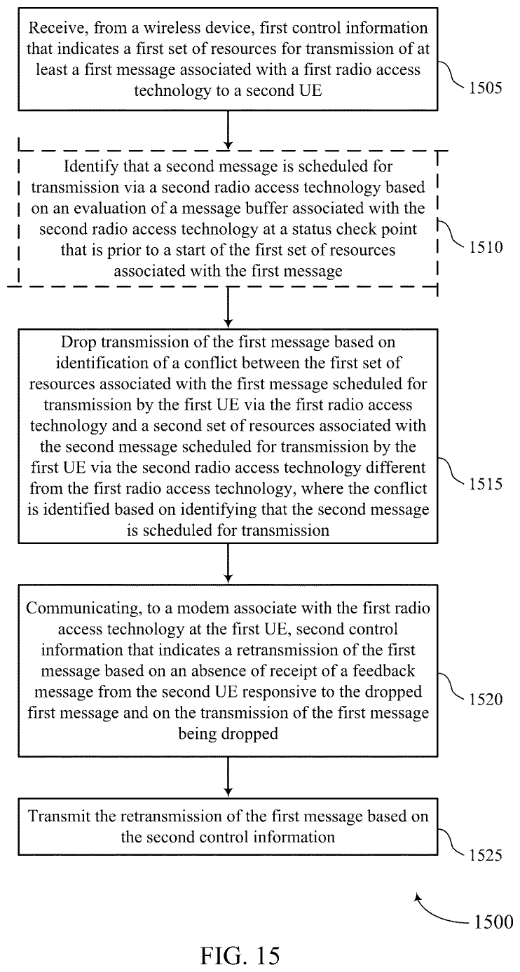

FIG. 15 illustrates a flowchart showing a method 1500 that supports techniques for mitigating adjacent channel coexistence interference in accordance with one or more aspects of the present disclosure. The operations of the method 1500 may be implemented by a UE or its components as described herein. For example, the operations of the method 1500 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1505, the method may include receiving, from a wireless device, first control information that indicates a first set of resources for transmission of at least a first message associated with a first RAT to a second UE. The operations of 1505 may be performed in accordance with examples as disclosed herein. In some examples, aspects of the operations of 1505 may be performed by a control information manager 1225 as described with reference to FIG. 12.

At 1510, the method may include identifying that a second message is scheduled for transmission via a second RAT based on an evaluation of a message buffer associated with the second RAT at a status check point that is prior to a start of the first set of resources associated with the first message. The operations of 1510 may be performed in accordance with examples as disclosed herein. In some examples, aspects of the operations of 1510 may be performed by a second RAT manager 1240 as described with reference to FIG. 12.

At 1515, the method may include dropping transmission of the first message based on identification of a conflict between the first set of resources associated with the first message scheduled for transmission by the first UE via the first RAT and a second set of resources associated with the second message scheduled for transmission by the first UE via the second RAT different from the first RAT, where the conflict is identified based on identifying that the second message is scheduled for transmission. The operations of 1515 may be performed in accordance with examples as disclosed herein. In some examples, aspects of the operations of 1515 may be performed by a first RAT manager 1230 as described with reference to FIG. 12.

At 1520, the method may include communicating, to a modem associated with the first RAT at the first UE, second control information that indicates a retransmission of the first message based on an absence of receipt of a feedback message from the second UE responsive to the dropped first message and on the transmission of the first message being dropped. The operations of 1520 may be performed in accordance with examples as disclosed herein. In some examples, aspects of the operations of 1520 may be performed by a first RAT manager 1230 as described with reference to FIG. 12.

At 1525, the method may include transmitting the retransmission of the first message based on the second control information. The operations of 1525 may be performed in accordance with examples as disclosed herein. In some examples, aspects of the operations of 1525 may be performed by a first RAT manager 1230 as described with reference to FIG. 12.

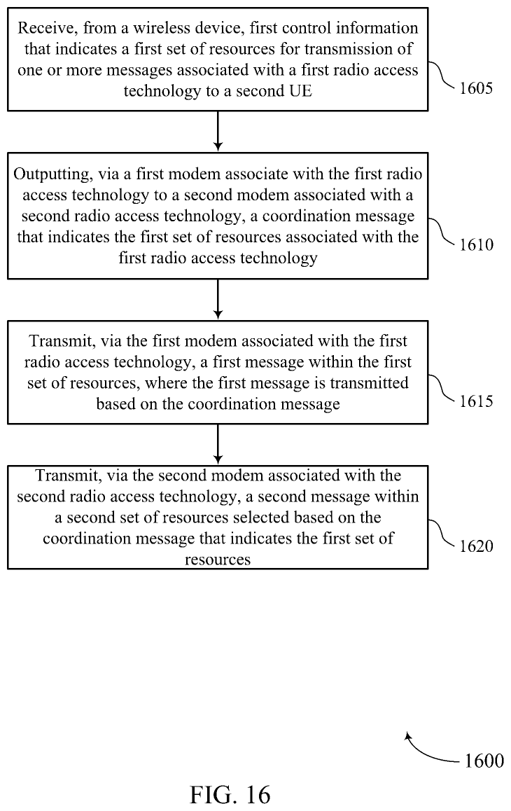

FIG. 16 illustrates a flowchart showing a method 1600 that supports techniques for mitigating adjacent channel coexistence interference in accordance with one or more aspects of the present disclosure. The operations of the method 1600 may be implemented by a UE or its components as described herein. For example, the operations of the method 1600 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1605, the method may include receiving, from a wireless device, first control information that indicates a first set of resources for transmission of one or more messages associated with a first RAT to a second UE. The operations of 1605 may be performed in accordance with examples as disclosed herein. In some examples, aspects of the operations of 1605 may be performed by a control information manager 1225 as described with reference to FIG. 12.

At 1610, the method may include outputting, via a first modem associated with the first RAT to a second modem associated with a second RAT, a coordination message that indicates the first set of resources associated with the first RAT. The operations of 1610 may be performed in accordance with examples as disclosed herein. In some examples, aspects of the operations of 1610 may be performed by an inter-RAT coordination manager 1235 as described with reference to FIG. 12.

At 1615, the method may include transmitting, via the first modem associated with the first RAT, a first message within the first set of resources, where the first message is transmitted based on the coordination message. The operations of 1615 may be performed in accordance with examples as disclosed herein. In some examples, aspects of the operations of 1615 may be performed by a first RAT manager 1230 as described with reference to FIG. 12.

At 1620, the method may include transmitting, via the second modem associated with the second RAT, a second message within a second set of resources selected based on the coordination message that indicates the first set of resources. The operations of 1620 may be performed in accordance with examples as disclosed herein. In some examples, aspects of the operations of 1620 may be performed by a second RAT manager 1240 as described with reference to FIG. 12.

The following provides an overview of aspects of the present disclosure:

Aspect 1: A method for wireless communication at a first UE, comprising: receiving, from a wireless device, first control information that indicates a first set of resources for transmission of at least a first message associated with a first RAT to a second UE; dropping transmission of the first message based at least in part on identification of a conflict between the first set of resources associated with the first message scheduled for transmission by the first UE via the first RAT and a second set of resources associated with a second message scheduled for transmission by the first UE via a second RAT different from the first RAT; communicating, to a modem associated with the first RAT at the first UE, second control information that indicates a retransmission of the first message based at least in part on an absence of receipt of a feedback message from the second UE responsive to the dropped first message and on the transmission of the first message being dropped; and transmitting the retransmission of the first message based at least in part on the second control information.

Aspect 2: The method of aspect 1, wherein the first UE is configured to perform retransmissions of the first message based at least in part on receipt of one or more feedback messages associated with the first message.

Aspect 3: The method of any of aspects 1 through 2, further comprising: identifying that the second message is scheduled for transmission via the second RAT based at least in part on an evaluation of a message buffer associated with the second RAT at a status check point that is prior to a start of the first set of resources associated with the first message, wherein the conflict is identified based at least in part on identifying that the second message is scheduled for transmission.

Aspect 4: The method of aspect 3, wherein a time interval between the status check point and the start of the first set of resources usable for the first message is based at least in part on one or more processing capabilities of the UE.

Aspect 5: The method of any of aspects 1 through 4, further comprising: identifying the conflict between the first set of resources associated with the first message and the second set of resources associated with the second message based at least in part on a start of the first set of resources associated with the first message occurring prior to an end of a CCA procedure associated with the second message in a time domain, wherein the transmission of the first message is dropped based at least in part on identification of the conflict.

Aspect 6: The method of any of aspects 1 through 5, further comprising: indicating, via the second control information, one or more parameters associated with the retransmission of the first message, wherein the retransmission of the first message is performed in accordance with the one or more parameters.

Aspect 7: The method of aspect 6, wherein the one or more parameters associated with the retransmission of the first message comprise an RV identifier associated with the retransmission of the first message, a second set of resources associated with the retransmission of the first message, or both.

Aspect 8: The method of any of aspects 1 through 7, further comprising: identifying a third set of resources reserved for retransmissions of the first message based at least in part on the first control information, wherein the retransmission of the first message is transmitted within the third set of resources.

Aspect 9: The method of any of aspects 1 through 8, wherein the second control information comprises a NACK message communicated to the modem via a MAC layer.

Aspect 10: The method of any of aspects 1 through 9, further comprising: selecting, via the modem, a third set of resources for the retransmission of the first message based at least in part on identification of the conflict and based at least in part on the first set of resources associated with the first message and the second set of resources associated with the second message comprising periodic resource sets, wherein the retransmission of the first message is transmitted within the third set of resources.

Aspect 11: The method of aspect 10, wherein the first set of resources associated with the first message is associated with a first SPS counter, the method further comprising: generating a second SPS counter based at least in part on identifying the conflict and based at least in part on the first set of resources and the second set of resources comprising periodic resource sets, wherein the third set of resources is selected based at least in part on the second SPS counter.

Aspect 12: The method of any of aspects 10 through 11, further comprising: transmitting an SCI that indicates the third set of resources based at least in part on selection of the third set of resources, wherein the retransmission of the first message is transmitted based at least in part on the SCI.

Aspect 13: The method of any of aspects 1 through 12, further comprising: comparing a first priority associated with the first message, the first RAT, or both, and a second priority associated with the second message, the second RAT, or both, the second priority greater than the first priority, wherein the transmission of the first message is dropped based at least in part on the comparison.

Aspect 14: The method of any of aspects 1 through 13, wherein the first RAT comprises an LTE RAT, a 4G RAT, a 5G RAT, an NR RAT, a 6G RAT, or any combination thereof, and the second RAT comprises a Wi-Fi access technology, a DSRC access technology, or both.

Aspect 15: The method of any of aspects 1 through 14, wherein the first RAT comprises an LTE-V2X RAT, an NR-V2X RAT, or both.

Aspect 16: A method for wireless communication at a first UE, comprising: receiving, from a wireless device, first control information that indicates a first set of resources for transmission of one or more messages associated with a first RAT to a second UE; outputting, via a first modem associated with the first RAT to a second modem associated with a second RAT, a coordination message that indicates the first set of resources associated with the first RAT; transmitting, via the first modem associated with the first RAT, a first message within the first set of resources, wherein the first message is transmitted based at least in part on the coordination message; and transmitting, via the second modem associated with the second RAT, a second message within a second set of resources selected based at least in part on the coordination message that indicates the first set of resources.

Aspect 17: The method of aspect 16, wherein outputting the coordination message comprises: outputting, via the coordination message, an indication of a periodicity associated with the first set of resources, wherein the second set of resources is selected based at least in part on the periodicity.

Aspect 18: The method of any of aspects 16 through 17, wherein outputting the coordination message comprises: outputting, via the coordination message, an indication of a SPS counter associated with the first set of resources, wherein the second set of resources is selected based at least in part on the SPS counter.

Aspect 19: The method of any of aspects 16 through 18, wherein the second set of resources are further selected based at least in part on a third set of resources associated with feedback responsive to messages transmitted via the first set of resources.

Aspect 20: The method of any of aspects 16 through 19, wherein the first RAT comprises an LTE RAT, a 4G RAT, a 5G RAT, an NR RAT, a 6G RAT, or any combination thereof, and the second RAT comprises a Wi-Fi access technology, a DSRC access technology, or both.

Aspect 21: The method of any of aspects 16 through 20, wherein the first RAT comprises an LTE-V2X RAT, an NR-V2X RAT, or both.

Aspect 22: An apparatus for wireless communication at a first UE, comprising a processor; and memory coupled with the processor, the processor configured to perform a method of any of aspects 1 through 15.

Aspect 23: An apparatus for wireless communication at a first UE, comprising at least one means for performing a method of any of aspects 1 through 15.

Aspect 24: A non-transitory computer-readable medium storing code for wireless communication at a first UE, the code comprising instructions executable by a processor to perform a method of any of aspects 1 through 15.

Aspect 25: An apparatus for wireless communication at a first UE, comprising a processor; and memory coupled with the processor, the processor configured to perform a method of any of aspects 16 through 21.

Aspect 26: An apparatus for wireless communication at a first UE, comprising at least one means for performing a method of any of aspects 16 through 21.

Aspect 27: A non-transitory computer-readable medium storing code for wireless communication at a first UE, the code comprising instructions executable by a processor to perform a method of any of aspects 16 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a first user equipment (UE), comprising:
a processor; and
memory coupled with the processor, the processor configured to:
receive, from a wireless device, first control information that indicates a first set of resources for transmission of at least a first message associated with a first radio access technology to a second UE;
drop transmission of the first message based at least in part on identification of a conflict between the first set of resources associated with the first message scheduled for transmission by the first UE via the first radio access technology and a second set of resources associated with a second message scheduled for transmission by the first UE via a second radio access technology.

2. The apparatus of claim 1, wherein the first UE is configured to perform retransmissions of the first message based at least in part on receipt of one or more feedback messages associated with the first message.

3. The apparatus of claim 1, wherein the processor is further configured to:
identify that the second message is scheduled for transmission via the second radio access technology based at least in part on an evaluation of a message buffer associated with the second radio access technology at a status check point that is prior to a start of the first set of resources associated with the first message, wherein the conflict is identified based at least in part on identifying that the second message is scheduled for transmission.

4. The apparatus of claim 3, wherein a time interval between the status check point and the start of the first set of resources usable for the first message is based at least in part on one or more processing capabilities of the UE.

5. The apparatus of claim 1, wherein the processor is further configured to:
identify the conflict between the first set of resources associated with the first message and the second set of resources associated with the second message based at least in part on a start of the first set of resources associated with the first message occurring prior to an end of a clear channel assessment procedure associated with the second message in a time domain, wherein the transmission of the first message is dropped based at least in part on identification of the conflict.

6. The apparatus of claim 1, wherein the processor is further configured to:
indicate, via the second control information, one or more parameters associated with the retransmission of the first message, wherein the retransmission of the first message is performed in accordance with the one or more parameters.

7. The apparatus of claim 6, wherein the one or more parameters associated with the retransmission of the first message comprise a redundancy version identifier associated with the retransmission of the first message, a second set of resources associated with the retransmission of the first message, or both.

8. The apparatus of claim 1, wherein the processor is further configured to:
identify a third set of resources reserved for retransmissions of the first message based at least in part on the first control information, wherein the retransmission of the first message is transmitted within the third set of resources.

9. The apparatus of claim 1, wherein the second control information comprises a negative acknowledgment message communicated to the modem via a medium access control layer.

10. The apparatus of claim 1, wherein the processor is further configured to:
select, via the modem, a third set of resources for the retransmission of the first message based at least in part on identification of the conflict and based at least in part on the first set of resources associated with the first message and the second set of resources associated with the second message comprising periodic resource sets, wherein the retransmission of the first message is transmitted within the third set of resources.

11. The apparatus of claim 10, wherein the first set of resources associated with the first message is associated with a first semi-persistent scheduling counter, wherein the processor is further configured to:
generate a second semi-persistent scheduling counter based at least in part on identifying the conflict and based at least in part on the first set of resources and the second set of resources comprising periodic resource sets, wherein the third set of resources is selected based at least in part on the second semi-persistent scheduling counter.

12. The apparatus of claim 10, further comprising:
an antenna array configured to transmit a sidelink control information that indicates the third set of resources based at least in part on selection of the third set of resources, wherein the retransmission of the first message is transmitted based at least in part on the sidelink control information.

13. The apparatus of claim 1, wherein the processor is further configured to:
compare a first priority associated with the first message, the first radio access technology, or both, and a second priority associated with the second message, the second radio access technology, or both, the second priority greater than the first priority, wherein the transmission of the first message is dropped based at least in part on the comparison.

14. The apparatus of claim 1, wherein the first radio access technology comprises a Long Term Evolution radio access technology, a Fourth Generation radio access technology, a Fifth Generation radio access technology, a New Radio access technology, a Sixth Generation radio access technology, or any combination thereof, and wherein the second radio access technology comprises a Wi-Fi access technology, a dedicated short range communication access technology, or both.

15. The apparatus of claim 1, wherein the first radio access technology comprises a Long Term Evolution vehicle-to-everything (LTE-V2X) radio access technology, a New Radio vehicle-to-everything (NR-V2X) radio access technology, or both.

16. An apparatus for wireless communication at a first user equipment (UE), comprising:
a processor; and
memory coupled with the processor, the processor configured to:
receive, from a wireless device, first control information that indicates a first set of resources for transmission of one or more messages associated with a first radio access technology to a second UE;
output, via a first modem associated with the first radio access technology to a second modem associated with the second radio access technology, a coordination message that indicates the first set of resources associated with the first radio access technology;
transmit, via the first modem associated with the first radio access technology, a first message within the first set of resources, wherein the first message is transmitted based at least in part on the coordination message; and
transmit, via the second modem associated with the second radio access technology, a second message within a second set of resources selected based at least in part on the coordination message that indicates the first set of resources.

17. The apparatus of claim 16, wherein, to output the coordination message, the processor is further configured to:
output, via the coordination message, an indication of a periodicity associated with the first set of resources, wherein the second set of resources is selected based at least in part on the periodicity.

18. The apparatus of claim 16, wherein, to output the coordination message, the processor is further configured to:
output, via the coordination message, an indication of a semi-persistent scheduling counter associated with the first set of resources, wherein the second set of resources is selected based at least in part on the semi-persistent scheduling counter.

19. The apparatus of claim 16, wherein the second set of resources are further selected based at least in part on a third set of resources associated with feedback responsive to messages transmitted via the first set of resources.

20. The apparatus of claim 16, wherein the first radio access technology comprises a Long Term Evolution radio access technology, a Fourth Generation radio access technology, a Fifth Generation radio access technology, a New Radio access technology, a Sixth Generation radio access technology, or any combination thereof, and wherein the second radio access technology comprises a Wi-Fi access technology, a dedicated short range communication access technology, or both.

21.-30. (canceled)
